(19) United States
(12) Patent Application Publication
(10) Pub. No.: US 2011/0282674 A1
(43) Pub. Date: Nov. 17, 2011

(54) MULTICHANNEL AUDIO CODING

(75) Inventor: Juha Ojanpera, Nokia (FI)

(73) Assignee: NOKIA CORPORATION, Espoo (FI)

(21) Appl. No.: 12/744,793

(22) PCT Filed: Nov. 27, 2007
(86) PCT No.: PCT/EP2007/062913

§ 371 Date: Nov. 28, 2010

(51) Int. Cl. H04B 1/66

(52) U.S. Cl. 704/500

(57) ABSTRACT

An encoder for encoding an audio signal comprising at least two channels configured to determine at least one audio signal image position value for the at least two channels of the audio signal; and calculate at least one audio signal image gain value associated with the at least one audio signal image position value.

### FIELD OF THE INVENTION

The present invention relates to coding, and in particular, but not exclusively to speech or audio coding.

### BACKGROUND OF THE INVENTION

Audio signals, like speech or music, are encoded for example for enabling an efficient transmission or storage of the audio signals.

Audio encoders and decoders are used to represent audio based signals, such as music and background noise. These types of coders typically do not utilise a speech model for the coding process, rather they use processes for representing all types of audio signals, including speech.

Speech encoders and decoders (codecs) are usually optimised for speech signals, and can operate at either a fixed or variable bit rate.

An audio codec can also be configured to operate with varying bit rates. At lower bit rates, such an audio codec may work with speech signals at a coding rate equivalent to a pure speech codec. At higher bit rates, the audio codec may code any signal including music, background noise and speech, with higher quality and performance.

In some audio codecs the input signal is divided into a limited number of bands. Each of the band signals may be quantized. From the theory of psychoacoustics it is known that the highest frequencies in the spectrum are perceptually less important than the low frequencies. This in some audio codecs is reflected by a bit allocation where fewer bits are allocated to high frequency signals than low frequency signals.

The original audio signal which is to be processed can be a mono audio signal or a multichannel audio signal containing at least a first and a second channel signal. An example of a multichannel audio signal is a stereo audio signal, which is composed of a left channel signal and a right channel signal.

Depending on the allowed bit rate, different encoding schemes can be applied to a stereo audio signal, whereby the left and right channel signals can be encoded independently from each other. Frequently a correlation exists between the left and the right channel signals, and this is typically exploited by more advanced audio coding schemes in order to further reduce the bit rate.

Bit rates can also be reduced by utilising a low bit rate stereo extension scheme. In this type of scheme, the stereo signal is encoded as a higher bit rate mono signal which is typically accompanied with additional side information conveying the stereo extension. At the decoder the stereo audio signal is reconstructed from a combination of the high bit rate mono signal and the stereo extension side information. The side information is typically encoded at a fraction of the rate of the mono signal.

Stereo extension schemes, therefore, typically operate at coding rates in the order of just a few kbps.

However, it is not possible to reproduce an exact replica of the stereo image at the decoder, with the decoder seeking to achieve a good perceptual replication of the original stereo audio signal.

The most commonly used techniques for reducing the bit rate of stereo and multichannel audio signals audio are the Mid/Side (MIS) stereo and Intensity Stereo (IS) coding schemes. Mid/Side coding, as described for example by J. D. Johnston and A. J. Ferreira in “Sum-difference stereo transform coding”, ICASSP-92 Conference Record, 1992, pp. 569-572, is used to reduce the redundancy between pairs of channels. In M/S, the left and right channel signals are transformed into sum and difference signals. Maximum coding efficiency is achieved by performing this transformation in both a frequency and time dependent manner. M/S stereo is very effective for high quality, high bit rate stereophonic coding.

In the attempt to achieve lower bit rates, IS has been used in conjunction with M/S coding, where IS constitutes a stereo extension scheme. IS coding is described in U.S. Pat. No. 5,539,829 and U.S. Pat. No. 5,606,618 whereby a portion of the spectrum is coded in mono mode, and this together with additional scaling factors for left and right channels is used to reconstruct the stereo audio signal at the decoder.

The scheme as used by IS can be considered to be part of a more general approach to coding multichannel audio signals known as spatial audio coding. Spatial audio coding transmits compressed spatial side information in addition to a basic audio signal. The side information captures the most salient perceptual aspects of the multi-channel sound image, including level differences, time/phase differences and inter-channel correlation/coherence cues. Binaural Cue Coding (BCC), as disclosed by C. Faller and F. Baumgarte “Binaural Cue Coding a Novel and Efficient Representation of Spatial Audio”, in ICASSP-92 Conference Record, 2002, pp. 1841-1844 represents a particular approach to spatial audio coding. In this approach several input audio signal channels are combined into a single “sum” signal, typically by means of down mixing process. Concurrently, the most important inter-channel cues describing the multi-channel sound image are extracted from the input channels and coded as BCC side information. At the decoder, the multi-channel output signal is generated by re-synthesising the sum signal with the inter-channel cue information.

These methods have been found to reproduce multichannel audio at a high quality using a relatively low amount of side information, for example a surround sound 5.1 channel arrangement may use 16 kbit/s for side information. However, these types of systems typically require considerable computer processing power in order to implement them, even for simple channel arrangements such as a stereo configuration.

### SUMMARY OF THE INVENTION

This invention proceeds from the consideration that whilst Binaural Cue Coding (BCC) produces high quality multi channel audio for side information utilising a relatively little bit-rate overhead, due to the high processing overhead it is not always possible to deploy such an algorithm. Thus in some circumstances it is desirable to employ algorithms which use less processing power whilst maintaining perceptual audio quality levels.

Embodiments of the present invention aim to address the above problem.

There is provided according to a first aspect of the present invention a method of encoding an audio signal comprising at least two channels, the method comprising: determining at least one audio signal image position value for the at least two channels of the audio signal; and calculating at least one audio signal image gain value associated with the at least one audio signal image position value.

The method for encoding an audio signal may further comprise: transforming each of the at least two channels of the audio signal into a frequency domain representation, the frequency domain representation comprising at least one group of spectral coefficients.

Transforming each of the at least two channels of the audio signal into a frequency domain representation, may further comprise performing an orthogonal discrete transform on each of the two channels of the audio signal.

The method of encoding an audio signal may further comprise: calculating a first relative energy value of at least one of the at least one group of spectral coefficients for a first channel of the at least two channels; calculating a second relative energy value of at least one of the at least one group of spectral coefficients for a second channel of the at least two channels;

Determining the at least one audio signal image position value may further comprise comparing the second relative energy level to the first relative energy level; wherein the at least one audio signal image position value is dependent on the comparing of the second relative energy level to the first relative energy level.

The audio signal image position value is preferably configured to identify at least one of the at least two channels.

The audio signal image position value for the at least one region is preferably configured to identify a first channel if the first relative energy level is greater than the second relative energy level.

The audio signal image position value for the at least one region is preferably configured to identify a second channel if the second relative energy level is greater than the first relative energy level.

Calculating the at least one audio signal image gain value may further comprise: determining the ratio of a maximum: of the first relative energy level; and the second relative energy level, to a minimum of: the first relative energy level; and the second relative energy level.

The method of encoding an audio signal may further comprise: quantizing the at least one audio signal image gain for the at least one group using at least one of at least two quantisation tables, wherein quantizing may further comprise: selecting one of a first quantisation table or a second quantisation table from the at least two quantisation tables, wherein the selection of the first quantisation table is preferably dependent on an audio signal image gain from a proceeding time period being quantized with a first predetermined index.

The selection of the second quantisation table is preferably dependent on the audio signal image gain from a proceeding sub band being quantized with a second predetermined index.

The method of encoding an audio signal may further comprise: generating a first energy function from a sequence of the calculated first relative energy values; wherein each value of the first energy function is dependent on the calculated first relative energy values for a predefined time period and further generating a second energy function from a sequence of the calculated second energy values, wherein each value of the second energy function is dependent on the calculated second relative energy values for a predefined time period, wherein the audio signal image position value is further dependent on the first energy function values and the second energy function values.

The audio signal image position value for a first instant is preferably dependent on at least two of the first energy function values and the second energy function values f.

Determining the audio signal image position value may comprise: determining a first audio signal image position value for a current time period dependent on the calculated first and second relative energy values for the current time period; correcting the first audio signal image position value dependent on the relative magnitudes of the first and second energy function values.

The method of encoding of an audio signal may further comprise: determining a level of frequency domain masking for the group; comparing the level of frequency domain masking against a threshold for the at least one group, wherein the audio signal image position value is further dependent on comparison result of the level of frequency domain masking against a threshold for the at least one group.

Determining of a level of frequency domain masking for the at least one group may further comprise: calculating a further relative energy value of at least one other group in the same time period of the audio signal; determining a proportion of the energy value contribution of the at least one other group distributed to the at least one group using a shaping function; and comparing the proportion of the value of the energy value contribution of the at least one other group to a threshold value.

The orthogonal discrete transform is preferably at least one of the following:—modified discrete cosine transform; discrete fourier transform; and shifted discrete fourier transform.

The energy function is preferably an exponential average gain estimator type function, and wherein the magnitude of a leakage factor of the exponential average gain estimator is preferably varied within a group.

According to a second aspect of the invention there is provided a method of decoding an audio signal comprising: receiving an encoded signal comprising at least in part an image position signal and a gain level signal; decoding from at least part of the encoded signal a mono synthetic audio signal; and generating at least two channels of audio signals dependent on the mono synthetic audio signal, the received audio signal image gain signal, and the audio signal image position signal.

The method of decoding an audio signal may further comprise determining at least one audio signal image gain value from the received audio signal image gain signal.

The audio signal may comprise a plurality of groups of spectral coefficients and determining at least one audio signal gain value may comprise determining at least one audio signal image gain value for each one of the plurality of groups of spectral coefficients

The method of decoding an audio signal may further comprise determining at least one audio signal image position value from the received audio signal image position signal.

The audio signal may comprise a plurality of groups of spectral coefficients and the determining at least one audio signal image position value may comprise determining at least one audio signal image position value for each one of the plurality of sub bands.

Generating at least two channels of audio signals may further comprise: generating at least two channel gains dependent on the audio signal image position value and the at least one gain level value, wherein at least one channel gain is associated with a first of the at least two channels of audio signals, and a further channel gain is associated with a second of the at least two channels of audio signals; generating a first of the at least two channels of audio signals by multiplying the mono synthetic signal with the at least one channel gain associated with the first channel; and generating a second of the at least two channels of audio signals by multiplying the mono synthetic signal with the further channel gain associated with the second channel.

Generating at least two channels of audio signals may further comprise transforming the first and second of at least two channels of audio signals into the time domain by a frequency to time domain transformation.

The frequency to time domain transformation may comprise an inverse orthogonal discrete transformation.

The determining at least one audio signal image gain value may further comprise: reading at least one audio signal image gain index from the gain level signal; selecting one of at least two dequantization functions; generating the at least one audio signal image gain value dependent on the at least one audio signal image gain index and the one of at least two quantization functions selected.

The selecting one of at least two quantisation functions may comprise: selecting the first quantisation function if the at least one audio signal image gain index for a previous frame has a first predetermined index value.

Selecting one of at least two quantization functions may further comprise selecting a second of the at least two quantization functions if the at least one audio signal image gain index for a previous frame has a second pre determined index value.

The first pre-determined index value is preferably zero and the second pre determined index value is preferably a non zero value.

The mono audio signal is preferably a frequency domain signal.

The mono audio signal is preferably a time domain signal, and wherein the method further comprises: transforming the time domain mono audio signal to a frequency domain mono audio signal.

The transforming the time domain audio signal to a frequency domain audio signal may comprise applying using a time to frequency domain orthogonal discrete transformation.

The orthogonal discrete transformation is preferably at least one of the following: a modified discrete cosine transformation; a discrete fourier transformation; and a shifted discrete fourier transformation.

The inverse orthogonal discrete transformation is preferably at least one of the following: a inverse modified discrete cosine transformation; a inverse discrete fourier transformation; and a inverse shifted discrete fourier transformation.

According to a third aspect of the invention there is provided an encoder for encoding an audio signal comprising at least two channels, configured to: determine at least one audio signal image position value for the at least two channels of the audio signal; and calculate at least one audio signal image gain value associated with the at least one audio signal image position value.

The encoder for encoding an audio signal may further be configured to: transform each of the at least two channels of the audio signal into a frequency domain audio signal, the frequency domain audio signal comprising at least one group of spectral coefficients.

The encoder for encoding an audio signal may be configured to: perform an orthogonal discrete transform on each of the two channels of the audio signal.

The encoder for encoding an audio signal may further be configured to: calculate a first relative energy value of at least one of the at least one group of spectral coefficients for a first channel of the at least two channels; and calculate a second relative energy value of at least one of the at least one group of spectral coefficients for a second channel of the at least two channels.

The encoder for encoding an audio signal may further be configured to compare the second relative energy level to the first relative energy level; wherein the at least one audio signal image position value is preferably dependent on the result of the comparison of the second relative energy level to the first relative energy level.

The audio signal image position value is preferably configured to identify at least one of the at least two channels.

The audio signal image position value for the at least one region is preferably configured to identify a first channel if the first relative energy level is greater than the second relative energy level.

The audio signal image position value for the at least one region is preferably configured to identify a second channel if the second relative energy level is greater than the first relative energy level.

Calculating the at least one audio signal image gain value may further comprise: determining the ratio of a maximum of the first relative energy level and the second relative energy level, to a minimum of the first relative energy level and the second relative energy level.

The encoder for encoding an audio signal may further be configured to: quantize the at least one audio signal image gain for the at least one group using at least one of at least two quantisation tables, and select one of a first quantisation table or a second quantisation table from the at least two quantisation tables, wherein the selection of the first quantisation table is dependent on an audio signal image gain from a proceeding time period being quantized with a first predetermined index.

The encoder for encoding an audio signal may further be configured to select the second quantization table dependent on the audio signal image gain from a proceeding sub band being quantized with a second predetermined index.

The encoder for encoding an audio signal may further be configured to: generate a first energy function from a sequence of the calculated first relative energy values; wherein each value of the first energy function is dependent on the calculated first relative energy values for a predefined time period and further generate a second energy function from a sequence of the calculated second energy values, wherein each value of the second energy function is dependent on the calculated second relative energy values for a predefined time period, wherein the audio signal image position value is further dependent on the first energy function values and the second energy function values.

The audio signal image position value for a first instant is preferably dependent on at least two of the first energy function values and the second energy function values.

The encoder for encoding an audio signal may further be configured to: determine a first audio signal image position value for a current time period dependent on the calculated first and second relative energy values for the current time period; and correct the first audio signal image position value dependent on the relative magnitudes of the first and second energy function values.

The encoder for encoding an audio signal may further be configured to: determine a level of frequency domain masking for the group; compare the level of frequency domain masking against a threshold for the at least one group, wherein the audio signal image position value is further dependent on comparison result of the level of frequency domain masking against a threshold for the at least one group.

The encoder for encoding an audio signal may further be configured to: calculate a further relative energy value of at least one other group in the same time period of the audio signal; determine a proportion of the energy value contribution of the at least one other group distributed to the at least one group using a shaping function; and compare the proportion of the value of the energy value contribution of the at least one other group to a threshold value.

The orthogonal discrete transform is preferably at least one of the following: a modified discrete cosine transform; a discrete fourier transform; and a shifted discrete fourier transform.

The energy function is preferably an exponential average gain estimator type function, and wherein the magnitude of a leakage factor of the exponential average gain estimator is preferably varied within a group.

According to a fourth aspect of the present invention there is provided a decoder for decoding an audio signal configured to: receive an encoded signal comprising at least in part an image position signal and a gain level signal; decode from at least part of the encoded signal a mono synthetic audio signal; and generate at least two channels of audio signals dependent on the mono synthetic audio signal, the received audio signal image gain signal, and the audio signal image position signal.

The decoder for decoding an audio signal may further be configured to determine at least one audio signal image gain value from the received audio signal image gain signal.

The audio signal may comprise a plurality of groups of spectral coefficients and determining at least one audio signal gain value may comprise determining at least one audio signal image gain value for each one of the plurality of groups of spectral coefficients

The decoder for decoding an audio signal may further be configured to determine at least one audio signal image position value from the received audio signal image position signal.

The audio signal may comprise a plurality of groups of spectral coefficients and the determining at least one audio signal image position value may comprise determining at least one audio signal image position value for each one of the plurality of sub bands.

The decoder for decoding an audio signal may further be configured to: generate at least two channel gains dependent on the audio signal image position value and the at least one gain level value, wherein at least one channel gain is associated with a first of the at least two channels of audio signals, and a further channel gain is associated with a second of the at least two channels of audio signals; generate a first of the at least two channels of audio signals by multiplying the mono synthetic signal with the at least one channel gain associated with the first channel; and generate a second of the at least two channels of audio signals by multiplying the mono synthetic signal with the further channel gain associated with the second channel.

The decoder for decoding an audio signal may further be configured to transform the first and second of at least two channels of audio signals into the time domain by a frequency to time domain transformation.

The frequency to time domain transform may comprise an inverse orthogonal discrete transform.

The decoder for decoding an audio signal may be configured to: read at least one audio signal image gain index from the gain level signal; select one of at least two dequantization functions; and generate the at least one audio signal image gain value dependent on the at least one audio signal image gain index and the one of at least two quantization functions selected.

The decoder for decoding an audio signal may further be configured to select the first quantisation function if the at least one audio signal image gain index for a previous frame has a first predetermined index value.

The decoder for decoding an audio signal may further be configured to select a second of the at least two quantization functions if the at least one audio signal image gain index for a previous frame has a second predetermined index value.

The first predetermined index value is preferably zero and the second pre determined index value is preferably a non zero value.

The mono audio signal is preferably a frequency domain signal.

The mono audio signal is preferably a time domain signal, and wherein the decoder is preferably further configured to transform the time domain mono audio signal to a frequency domain mono audio signal.

The decoder for decoding an audio signal may further be configured to apply a time to frequency domain orthogonal discrete transformation to the time domain mono audio signal.

The orthogonal discrete transformation is preferably at least one of the following: a modified discrete cosine transformation; a discrete fourier transformation; and a shifted discrete fourier transformation.

The inverse orthogonal discrete transformation is preferably at least one of the following: a inverse modified discrete cosine transformation; a inverse discrete fourier transformation; and a inverse shifted discrete fourier transformation.

An apparatus may comprise an encoder as featured above.

An apparatus may comprise a decoder as featured above.

An electronic device may comprise an encoder as featured above.

An electronic device may comprise a decoder as featured above.

A chipset may comprise an encoder as featured above.

A chipset may comprise a decoder as featured above.

According to a fifth aspect of the present invention there is provided a computer program product configured to perform a method for encoding an audio signal comprising: determining at least one audio signal image position value for the at least two channels of the audio signal; and calculating at least one audio signal image gain value associated with the at least one audio signal image position value.

According to a sixth aspect of the present invention there is provided a computer program product configured to perform a method for decoding an audio signal comprising: receiving an encoded signal comprising at least in part an image position signal and a gain level signal; decoding from at least part of the encoded signal a mono synthetic audio signal; and generating at least two channels of audio signals dependent on the mono synthetic audio signal, the received audio signal image gain signal, and the audio signal image position signal.

According to a seventh aspect of the present invention there is provided an encoder for encoding an audio signal comprising: first signal processing means for determining at least one audio signal image position value for the at least two channels of the audio signal; and second signal processing means for calculating at least one audio signal image gain value associated with the at least one audio signal image position value.

According to an eighth aspect of the present invention there is provided a decoder for decoding an audio signal comprising: receiving means to receive an encoded signal comprising at least in part an image position signal and a gain level signal; decoding means for decoding from at least part of the encoded signal a mono synthetic audio signal; and processing means for generating at least two channels of audio signals dependent on the mono synthetic audio signal, the received audio signal image gain signal, and the audio signal image position signal.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2 shows schematically an audio codec system employing embodiments of the present invention;

FIG. 3 shows schematically an encoder part of the audio codec system shown in FIG. 2;

FIG. 4 shows schematically a region encoder part of the audio codec system shown in FIG. 3;

FIG. 5 shows a flow diagram illustrating the operation of an embodiment of the audio encoder as shown in FIG. 3 according to the present invention;

FIG. 6 shows a flow diagram illustrating the operation of an embodiment of the region encoder as shown in FIG. 4 according to the present invention;

FIG. 7 shows a schematically an decoder part of the audio codec system shown in FIG. 2; and

FIG. 8 shows a flow diagram illustrating the operation of an embodiment of the audio decoder as shown in FIG. 7 according to the present invention.

### DESCRIPTION OF PREFERRED EMBODIMENTS OF THE INVENTION

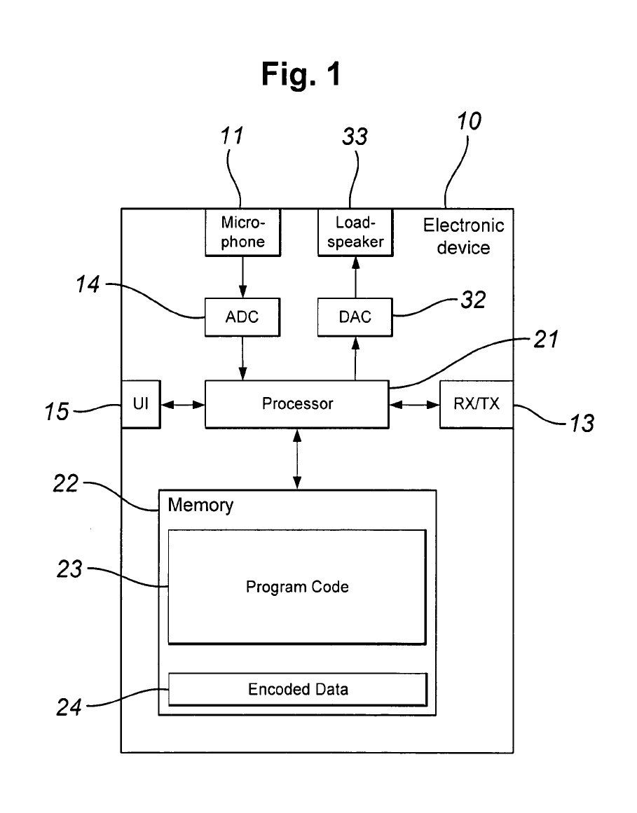

The following describes in more detail possible mechanisms for the provision of a low complexity multichannel audio coding system. In this regard reference is first made to FIG. 1 schematic block diagram of an exemplary electronic device 10, which may incorporate a codec according to an embodiment of the invention.

The electronic device 10 may for example be a mobile terminal or user equipment of a wireless communication system.

The electronic device 10 comprises a microphone 11, which is linked via an analogue-to-digital converter 14 to a processor 21. The processor 21 is further linked via a digital-to-analogue converter 32 to loudspeakers 33. The processor 21 is further linked to a transceiver (TX/RX) 13, to a user interface (UI) 15 and to a memory 22.

The processor 21 may be configured to execute various program codes. The implemented program codes comprise an audio encoding code for encoding a combined audio signal and code to extract and encode side information pertaining to the spatial information of the multiple channels. The implemented program codes 23 further comprise an audio decoding code. The implemented program codes 23 may be stored for example in the memory 22 for retrieval by the processor 21 whenever needed. The memory 22 could further provide a section 24 for storing data, for example data that has been encoded in accordance with the invention.

The encoding and decoding code may in embodiments of the invention be implemented in hardware or firmware.

The user interface 15 enables a user to input commands to the electronic device 10, for example via a keypad, and/or to obtain information from the electronic device 10, for example via a display. The transceiver 13 enables a communication with other electronic devices, for example via a wireless communication network.

It is to be understood again that the structure of the electronic device 10 could be supplemented and varied in many ways.

A user of the electronic device 10 may use the microphone 11 for inputting speech that is to be transmitted to some other electronic device or that is to be stored in the data section 24 of the memory 22. A corresponding application has been activated to this end by the user via the user interface 15. This application, which may be run by the processor 21, causes the processor 21 to execute the encoding code stored in the memory 22.

The analogue-to-digital converter 14 converts the input analogue audio signal into a digital audio signal and provides the digital audio signal to the processor 21.

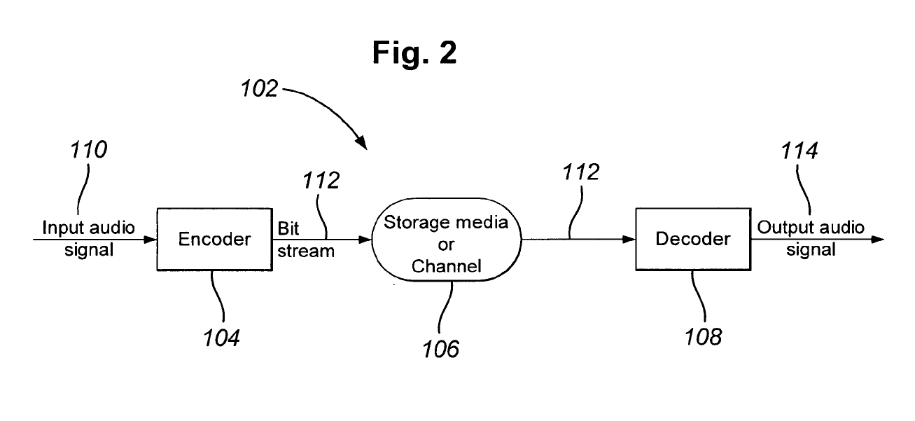

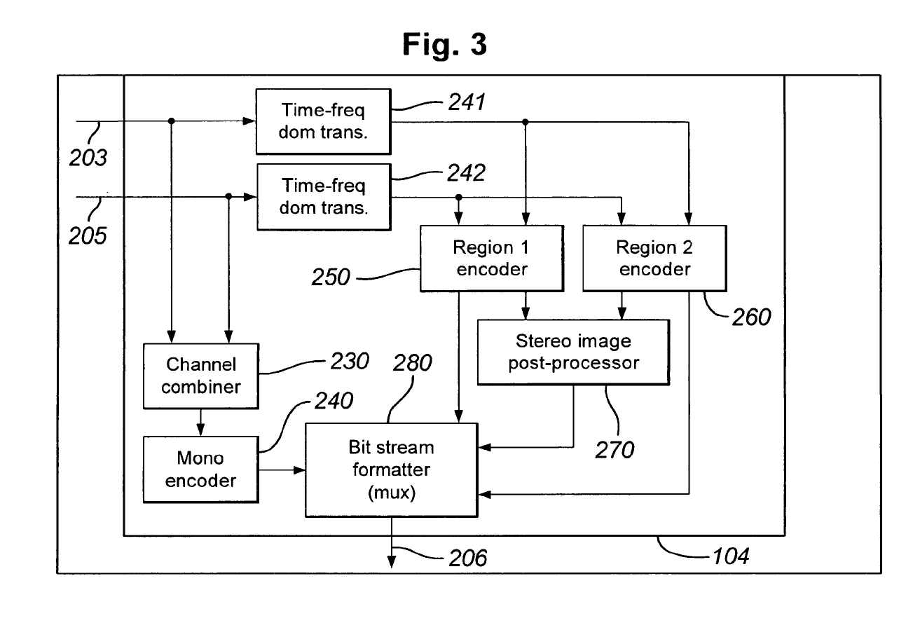

The processor 21 may then process the digital audio signal in the same way as described with reference to FIGS. 2 and 3.

The resulting bit stream is provided to the transceiver 13 for transmission to another electronic device. Alternatively, the coded data could be stored in the data section 24 of the memory 22, for instance for a later transmission or for a later presentation by the same electronic device 10.

The electronic device 10 could also receive a bit stream with correspondingly encoded data from another electronic device via its transceiver 13. In this case, the processor 21 may execute the decoding program code stored in the memory 22. The processor 21 decodes the received data, and provides the decoded data to the digital-to-analogue converter 32. The digital-to-analogue converter 32 converts the digital decoded data into analogue audio data and outputs them via the loudspeakers 33. Execution of the decoding program code could be triggered as well by an application that has been called by the user via the user interface 15.

The received encoded data could also be stored instead of an immediate presentation via the loudspeakers 33 in the data section 24 of the memory 22, for instance for enabling a later presentation or a forwarding to still another electronic device.

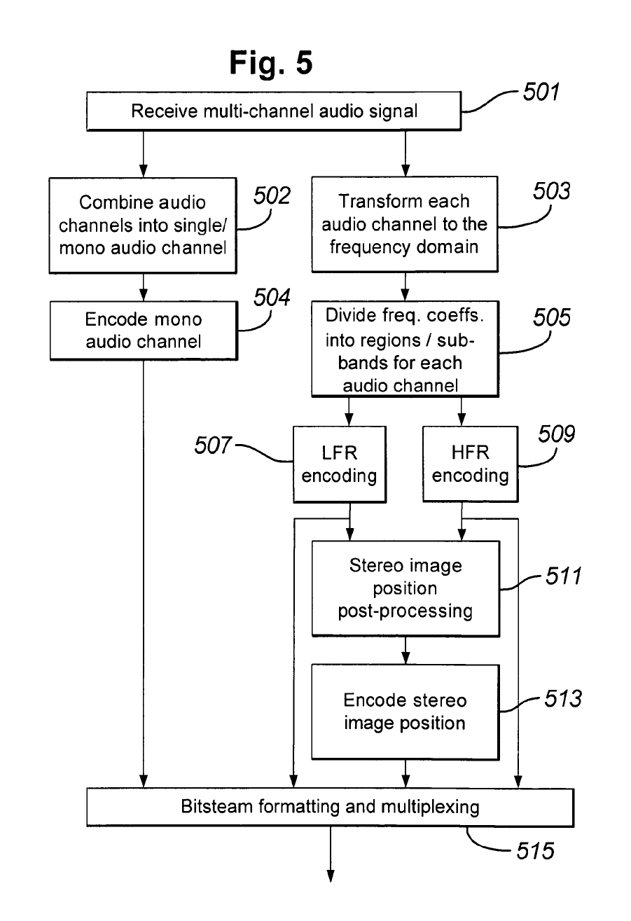

It would be appreciated that the schematic structures described in FIGS. 2, 3, 4 and 7 and the method steps in FIGS. 5, 6 and 8 represent only a part of the operation of a complete audio codec as exemplarily shown implemented in the electronic device shown in FIG. 1.

The general operation of audio codecs as employed by embodiments of the invention is shown in FIG. 2. General audio coding/decoding systems consist of an encoder and a decoder, as illustrated schematically in FIG. 2. Illustrated is a system 102 with an encoder 104, a storage or media channel 106 and a decoder 108.

The encoder 104 compresses an input audio signal 110 producing a bit stream 112, which is either stored or transmitted through a media channel 106. The bit stream 112 can be received within the decoder 108. The decoder 108 decompresses the bit stream 112 and produces an output audio signal 114. The bit rate of the bit stream 112 and the quality of the output audio signal 114 in relation to the input signal 110 are the main features, which define the performance of the coding system 102.

FIG. 3 depicts schematically an encoder 104 according to an exemplary embodiment of the invention. The encoder 104 comprises inputs 203 and 205 which are arranged to receive an audio signal comprising of two channels. The two channels 203, 205 may be arranged in embodiments of the invention as a stereo pair, in other words comprising a left and a right channel. It is to be understood that further embodiments of the present invention may be arranged to receive more than two input audio signal channels, for example a six channel input arrangement may be used to receive a 5.1 surround sound audio channel configuration.

The inputs 203 and 205 are connected to a channel combiner 230, which combines the inputs into a single channel. The output from the channel combiner is connected to an audio encoder 240, which is arranged to encode the mono audio signal input.

The inputs 203 and 205 are also each additionally connected to time domain to frequency domain transformation stages 241 and 242, with input 203 being connected to time domain to frequency domain transform stage 241, and input 205 being connected to time domain to frequency domain transform stage 242. The time domain to frequency domain transform stages are configured to output frequency domain representations of the respective input signals. The frequency domain output from the time domain to frequency domain transform stage 241 may be connected to an input of the Region 1 encoding stage 250 and an input of the Region 2 encoding stage 260. Additionally, the frequency domain output from the time domain to frequency domain transform stage 242 may also be connected to the a further input of the Region 1 encoding stage 250 and a further input of the Region 2 encoding stage, 260.

The region encoders 250, 260 are configured to output frequency based spatial information. One set of outputs from each of the region encoders may be connected to an input of the stereo image post processor 270. In addition a further set of outputs from the region encoders 250 and 260 are configured to be connected directly to the input of a bitstream formatter 280 (which in some embodiments of the invention is also known as the bitstream multiplexer). In addition to receiving the region encoder data based spatial information from the region encoders 250, 260, the bitstream formatter is further arranged to receive as additional inputs the output from a stereo image post processor 270 and an encoded output from an audio encoder 240. The bitstream formatter 280 is configured to output the output bitstream 112 via the output 206.

The operation of these components is described in more detail with reference to the flow chart FIG. 5 showing the operation of the encoder 104.

The audio signal is received by the coder 104. In a first embodiment of the invention the audio signal is a digitally sampled signal. In other embodiments of the present invention the audio input may be an analogue audio signal, for example from a microphone 6, which is analogue to digitally (A/D) converted. In further embodiments of the invention the audio input is converted from a pulse code modulation digital signal to amplitude modulation digital signal. The receiving of the audio signal is shown in FIG. 5 by step 501.

The channel combiner 230 receives both the left and right channels of the stereo audio signal and combines them into a single mono audio channel. In some embodiments of the present invention this may take the form of simply adding the left and the right channel samples and then dividing the sum by two. This process is typically performed on a sample by sample basis. In further embodiments of the invention, especially those which deploy more than two input channels, down mixing using matrixing techniques may be used to combine the channels. This process of combination may be performed either in the time or frequency domains.

The combining of audio channels is shown in FIG. 5 by step 502.

The audio (mono) encoder 240 receives the combined single channel audio signal and applies a suitable coding scheme upon the signal. In an embodiment of the invention the coder 240 may transform the signal into the frequency domain by the means of a suitable discrete unitary transform, of which non limiting examples may include the Discrete Fourier Transform (DCT) or the Modified Discrete Cosine Transform (MDCT). In other embodiments of the invention the audio encoder 240 may employ a codec which operates an analysis filter bank structure in order to generate a frequency domain based representation of the signal. Examples of the analysis filter bank structures may include but are not limited to quadrature mirror filter bank (QMF) and cosine modulated Pseudo QMF filter banks.

The signal may in some embodiments be further grouped into sub bands and each sub band may be quantised and coded using the information provided by a psychoacoustic model. The quantisation settings as well as the coding scheme may be dictated by the applied psychoacoustic model. The quantised, coded information is sent to the bit stream formatter 280 for creating a bit stream 12.

The encoding of the single channel audio signal is shown in FIG. 5 by step 504.

In other embodiments of the invention other audio codecs may be employed in order to encode the combined single channel audio signal. Examples of these further embodiments include but are not limited to advanced audio coding (AAC), MPEG I layer III (MP3), the ITU-T Embedded variable rate (EV-VBR) speech coding baseline codec, Adaptive Multirate Rate-Wide band (AMR-WB), and Adaptive Multirate Rate-Wideband Plus (AMR-WB+).

The left channel audio signal (in other words the signal received on the first input 203) is received by the first time domain to frequency domain transformation stage 241 which is configured to transform the received signal into the frequency domain represented as frequency based coefficients.

Concurrently, the right channel audio signal (in other words the signal received on the second input 205) is received by the second time domain to frequency domain transformation stage 242 which is configured to transform the received signal into the frequency domain and represented as frequency based coefficients.

In a first embodiment of the present invention the time domain to frequency domain transformation stages 241 and 242 are based on a variant of the discrete fourier transform (DFT). These variants of the DFT may be the shifted discrete fourier transform (SOFT).

In further embodiments of the present invention the time domain to frequency domain transformation stages may utilise discrete orthogonal transformations, such as the discrete fourier transform (DFT), the modified discrete cosine transform (MDCT), the modified discrete sine transform (MOST) and modified lapped transform (MLT).

The transformation of the left and right audio channels into the frequency domain is exemplary depicted by step 503 in FIG. 5.

In embodiments of the invention the time domain to frequency domain transformation stages 241, 242 may divide each spectral frame within each channel into at least two frequency regions. The time domain to frequency transformation stages 241, 242 may divide each spectral frame into higher and lower frequency regions and thus dividing the higher and lower frequency region coefficients. Thus, a first region may be those spectral coefficients associated with the lower frequencies, and a second region may be those spectral coefficients associated with the higher frequencies.

It is to be understood that further embodiments of the invention may divide the signal into more than two regions, where the coefficients may be distributed to each region in a hierarchical manner.

Furthermore the time domain to frequency domain transformation stages 241, 242 may group the frequency coefficients for each frame into sub bands within each region. Each sub band may contain a number of frequency (or spectral) coefficients. The distribution of frequency coefficients to sub bands may be determined according to psychoacoustic principles.

In some embodiments of the invention the division of each frame into regions and the grouping of coefficients into sub bands may be carried out within the region encoder 250, 260.

The division of each channel into different frequency regions and sub bands is shown as step 505, in FIG. 5.

For example in an exemplary embodiment of the invention a signal with a sampling frequency of 32 kHz and 20 ms frame size may be divided into two regions. The first region, the lower frequency region, spans the frequency range 775 Hz to 7700 Hz and the second region, the higher frequency region, spans the frequency range 7700 Hz to 16000 Hz. The 20 ms frame may be transformed into 640 MDCT coefficients, and the spectral coefficients may be distributed according to the critical bands of the human hearing system. This may be represented as, where the sub bands approximately coincide with the boundaries of the critical bands.

Thus in embodiments of the invention a series of offset values, which identify when the end of a sub-band has been reached with regards to the spectral coefficient index, may be defined. One embodiment of the invention may define the offset values for the sub-bands and regions using the above region and frame variables as follows:

For Region 1:

offset₁=[31,37,43,51,59,69,80,93,108,126,148,176,212,256,308]

For Region 2:

offset₁=[308,370,470,640]

The region encoding stages 250 and 260, receive the spectral coefficients from the time domain to frequency domain transformation stages 241, 242 respectively. The region encoding stages 250, 260 process the spectral coefficients associated with the left and right channels for each frame and each frequency region, in order to determine the stereo image position and associated energy level within the channel pair.

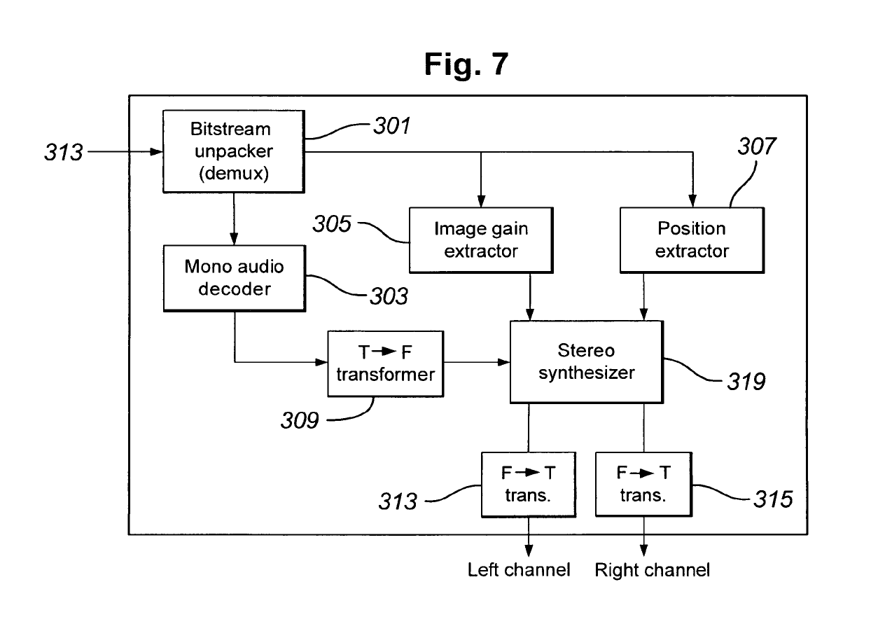

This is performed for each region separately and is exemplary depicted by region encoding stages 250 and 260 in FIG. 3 and by the steps 509 and 507 in FIG. 7.

The first region encoder 250 performs a lower frequency region coding as shown by the step 507 of FIG. 5. The second region encoder 260 performs a higher frequency region coding as shown by the step 507 of FIG. 5.

It is to be understood that further embodiments of the present invention may deploy a different number of region encoding stages in accordance with the division of the frequency spectrum into a number of different regions.

It is to be further understood that it may be possible to process the spectral coefficients associated with the channel pair as one whole frequency region within a single region coder (not shown in FIG. 3).

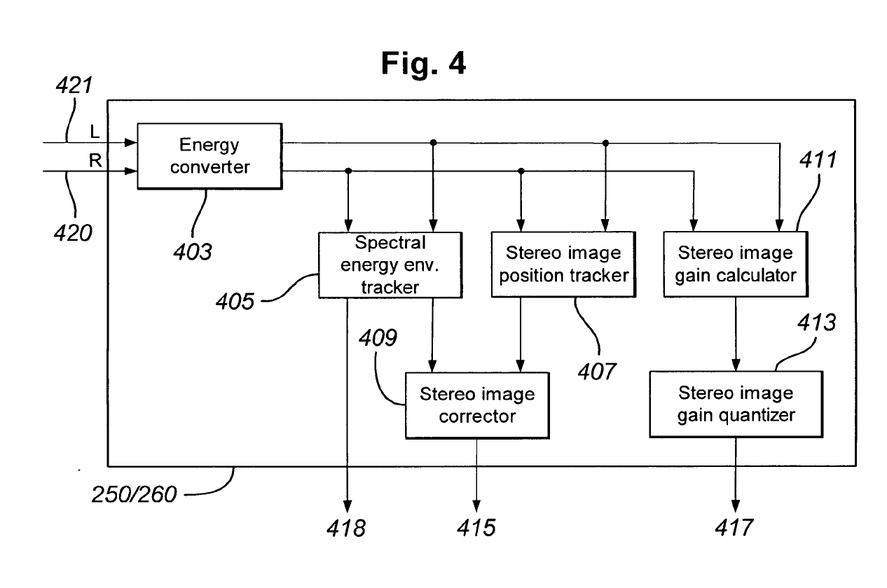

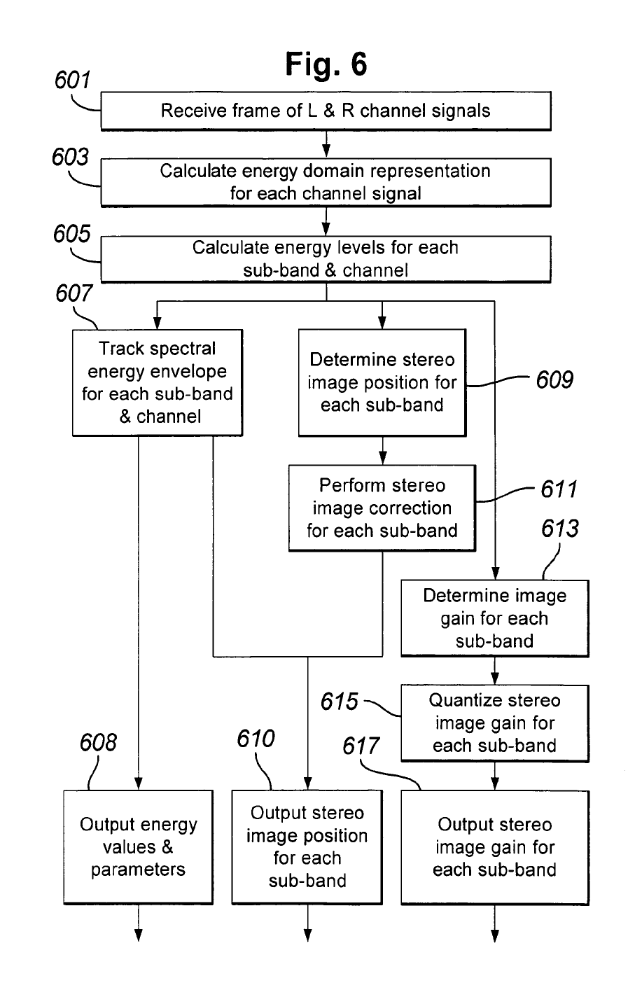

FIG. 4 exemplary depicts the schematic processing components within a region encoder such as the first and second region encoders 250, 260 shown in FIG. 3. The operation of the region encoder will hereafter be described in more detail in conjunction with the flow chart of FIG. 6.

The energy converter 403 receives via the channels inputs 421 and 420 region frequency coefficients (which in the two region example may be the lower frequency region and the higher frequency region) on a frame by frame basis. The channel input region frequency coefficients may be associated with the left and right channels of a stereo pair.

As described above in the embodiment shown in FIG. 3, the first region encoder 250 receives the lower frequency region coefficients, and the second region encoder 260 receives the higher frequency region coefficients.

The receiving of the coefficients is shown by step 601 in FIG. 6.

The energy convertor 403 converts the input spectral samples for each channel into the energy domain. In the first embodiment of the invention the input spectral samples will be complex since they may be obtained as a result of a shifted discrete fourier transform (SDFT).

In a first embodiment of the invention the energy converter may generate energy values for each index by summing the squares of the real and imaginary components for each spectral coefficient index. This step may be represented as

E_{L}(i)=f_{L}_{ᵣₑₐₗ}(i)²+f_{L}_{_{imag}}(i)²,0≦i<N

E_{R}(i)=f_{R}_{ᵣₑₐₗ}(i)²+f_{R}_{_{imag}}(i)² (1)

where f_{L} and f_{R} are the complex valued SDFT samples of the left and right channels, respectively, N is the size of the frame, and E_{L} and E_{R} are the energy domain representations for the left and right channels respectively.

This energy determination stage is depicted by the step 603 in FIG. 6.

As indicated previously further embodiments of the invention may utilise different frequency transformations in order to obtain the spectral coefficients. In such embodiments the coefficients may be real whereby the energy domain parameter may be determined by squaring the spectral coefficients.

The output, for each channel, of the energy converter is connected to the spectral energy envelope tracker 405.

The spectral energy envelope tracker 405 may initially calculate the energy level for each spectral sub band by summing for each sub-band the spectral coefficient energy values calculated by the energy converter. This for example may be represented according to the following equation:

$${e}_{L} ( i ) = {\sum }_{j = {offset}_{1} [ i ]}^{{offset}_{1} [ i + 1 ] - 1} {E}_{L} ( j ) , 0 \leq i < M$$

$${e}_{R} ( i ) = {\sum }_{j = {offset}_{1} [ i ]}^{{offset}_{1} [ i + 1 ] - 1} {E}_{R} ( j )$$

where offset₁ is the frequency offset table describing the frequency index offsets for each spectral sub band, and M is the number of spectral sub bands present in the region.

This initial energy calculation is depicted by step 605 in FIG. 6.

In some embodiments of the invention the initial energy calculation is performed in the energy converter 403 and supplied to the spectral energy envelope tracker 405.

The spectral energy envelope tracker 405 may then use the initial energy calculation value to update a spectral energy envelope tracking algorithm. This algorithm may then be used to track the change of spectral energy from one frame to the next and may be calculated for each sub band within each channel. Further, the algorithm may be made adaptive such that the energy spectral envelope value for a current frame is predicted from a previous energy spectral envelope value and a current energy level for each sub band and channel.

The spectral energy envelope tracker 405 may use in embodiments of the invention an exponential average gain estimator approach to track the spectral energy envelope. In this embodiment the rate of adaptation of the algorithm may be controlled by means of a leakage factor. The leakage factor can be viewed as a value (between 0-1) that indicates how much past (energy) contribution is allowed to be present in current frame/sub-band. In order to track the different rates of changing stereo scenes, it may be advantageous to have a tracking algorithm which utilises a spread of leakage factors. The spectral energy envelope tracker may for example operate the following pseudo code:

```
for(delay=2; delay > 0; delay−−)
    for(j = 0; j < 6; j++)
        for(sb = 0; sb < M; sb++)
        {
            energyL[delay][j][sb] = energyL[delay − 1][j][sb]
            energyR[delay][j][sb] = energyR[delay − 1][j][sb]
        }
for(sb = 0; sb < M; sb++)
{
    startAdapt = 0.9;
    for(j = 0; j < 5; j++)
    {
        energyL[0][j][sb] = energyL[0][j][sb] · startAdapt +
        e_{L}(sb) · (1.0 − startAdapt)
        energyR[0][j][sb] = energyR[0][j][sb] · startAdapt +
        e_{R}(sb) · (1.0 − startAdapt)
        startAdapt = startAdapt − 0.2;
    }
    energyL[0][5][sb] = e_{L}(sb)
    energyR[0][5][sb] = e_{R}(sb)
}
```

The spectral energy envelope tracker 405 according to the above embodiment first performs a initialization for the current frame of the previous frame energy values—in other words the previous frame energy value is redefined as being the second previous frame energy value and the current energy value is redefined at the previous frame energy value.

The spectral energy envelope tracker 405 then performs a loop for each of the sub-bands.

Using the leakage factors, startAdapt, spread between 0.1 and 0.9 with a granularity of 0.2, a total of 6 adaptation levels are offered. In other words 6 differing energy envelope tracking functions are provided each of which generate a current energy envelope energy value by weighting the sum of the current energy value e_{R} and a previous frame energy envelope value, for example the right channel energy envelope value energyR[0][j][sb] where j is the tracking function leakage factor index and sb is the sub-band index).

The last envelope tracking function uses only the current energy value—in other words weights the sum completely.

These leakage factors have been experimentally determined and have been found to offer a good range of factors whereby both fast and slow stereo scene changes may be tracked.

It is to be understood that further embodiments of the present invention, may deploy different adaptation rates (leakage factors) in accordance with different stereo scene changes. It is to be further understood that other embodiments may track the spectral energy envelope by other means beside an exponential average estimator approach, for example a moving average method with a smoothing window function or a low pass filtering technique may be used to track the changes.

The spectral energy envelope tracking process is depicted by step 607 in FIG. 6.

The stereo image position tracker 407 assigns one of the two channels to each sub band within the region. For example, in this exemplary embodiment each sub band may be assigned a stereo image position of either a left or right channel.

The stereo image position tracker 407 receives as an input the energy values (coefficients) from each of the sub bands associated with both the left and right channels as calculated in the energy converter 403.

The stereo image position tracker 407 uses the energy information to calculate the stereo image position for each sub band in the region being processed by the region encoder 250, 260.

The region encoder 250 may determine the stereo image position for each sub-band by determining a gain factor (level_{L}, level_{R}) for each channel on a per sub band basis. The gain factor may be based on the relative energies present within the sub band between the left and right channel. For example in one embodiment the gain factors per sub band may be determined by the square root of the fraction of the determined channel energy value over the total energy for both channels. The relative magnitude of the gain factor between right and left channel may be used to determine the stereo image position within the sub band by comparing the two relative magnitudes and selecting the channel which has the greatest value.

Thus in an exemplary embodiment of the present invention, the stereo image position for the sub band i, position (i), may be expressed as

$$position ( i ) = \{ \begin{matrix}LeftPos , & {level}_{L} ( i ) > {level}_{R} ( i ) \\ RightPos , & otherwise ,\end{matrix} \\ 0 \leq i < M \\ {level}_{L} ( i ) = \sqrt{\frac{{e}_{L} ( i )}{( {e}_{L} ( i ) + {e}_{R} ( i ) )}} \\ {level}_{R} ( i ) = \sqrt{\frac{{e}_{R} ( i )}{( {e}_{L} ( i ) + {e}_{R} ( i ) )}}$$

This stereo image position tracking finding the stereo image position for each sub band within each channel is depicted by step 609 in FIG. 6.

The outputs from the stereo image position calculator and spectral energy envelope tracker are connected to the stereo image corrector 409.

The stereo image position corrector uses the stereo image position information from the stereo image position tracker 407 and the spectral energy tracking data from the spectral energy envelope tracker 405 to smooth out any sudden transitional changes to the stereo image positional profile.

This may typically be done by using energy and positional data from past, current and future frames.

In an exemplary embodiment of the present invention, the stereo image corrector 409 may determine if there are any ‘unnecessary’ changes to the stereo image position for each sub band. The stereo image corrector 409 may use the following two sections of pseudo code to determine if there are any ‘unnecessary’ changes.

```
for(sb = 0; sb < M; sb++)
{
    if(positionₜ₋₁(sb) == positionₜ₊₁(sb))
        positionₜ(sb) = positionₜ₋₁(sb);
    else if(positionₜ₋₁(sb) == RightPos)
    {
        if(positionₜ(sb) == LeftPos)
            if(stThr1 < 3)
                positionₜ(sb) = positionₜ₋₁(sb)
    }
    else if(positionₜ₋₁(sb) == LeftPos)
    {
        if(positionₜ(sb) == RightPos)
            if(stThr2 < 3)
                positionₜ(sb) = positionₜ₋₁(sb)
    }
}
```

where positionₜ₋₁ and positionₜ₊₁ are the previous and next frame stereo positions of the specified sub band respectively, and stThr1 and stThr2 are the energy thresholds which may be used to obtain stationary stereo position over time.

In other words the stereo image corrector 409, in a first embodiment of the invention for each sub band performs the following steps:

Check if the previous frame stereo position is the same as the next frame stereo position. If the two are the same then the current frame stereo position is fixed to be the same as the previous frame stereo position. In other words this operation prevents the stereo position from oscillating from frame to frame.

Check if the previous frame stereo position is different from the current frame stereo position. If there is a difference then the stereo image corrector 409 checks an energy threshold value. If the energy threshold is less than a predefined value, in the above example less than 3, then the stereo image corrector 409 modifies the current frame stereo position to be the same as the previous frame stereo position.

The energy thresholds stThr1 and stThr2, in other words the right to left channel position switch check and the left to right channel position switch check respectively, may be determined by the stereo image corrector 409 by using the following operations:

Firstly count up the number of times over all adaptive levels where the energy envelope value for the potential switch channel increases from frame to frame. This frame to frame comparison is done for the next frame, current frame, and previous frame—in other words the count is increased where the next frame envelope value is greater than the current frame envelope value, the current frame envelope value is greater than the previous frame envelope value, and the previous envelope value is greater than the second previous envelope value. This produces a first value (lUp, rUp).

Secondly count up the number of times over all adaptive levels where the energy envelope value for the previous channel position channel decreases from frame to frame. This frame to frame comparison is done for the next frame, current frame, and previous frame—in other words the count is increased where the next frame envelope value is less than the current frame envelope value, the current frame envelope value is less than the previous frame envelope value, and the previous envelope value is less than the second previous envelope value. This produces a second value (rDown, lDown).

Then the switch value stThr1 and stThr2 is the sum of the first and second values.

This operation can be represented by the following pseudocode:

```
for(i = 2, lUp = 0; i > 0; i−−)
    for(j = 0; j < 6; j++)
        if(energyL[i − 1][j][sb] > energyL[i][j][sb])
            lUp++;
for(j = 0; j < 6; j++)
    if(energyLₜ₊₁[0][j][sb] > energyL[0][j][sb])
        lUp++;
for(i = 2, rDown = 0; i > 0; i−−)
    for(j = 0; j < 6; j++)
        if(energyR[i − 1][j][sb] < energyR[i][j][sb])
            rDown++;
for(j = 0; j < 6; j++)
    if(energyRₜ₊₁[0][j][sb] < energyR[0][j][sb])
        rDown++;
stThr1 = rDown + lUp;
for(i = 2, lDown = 0; i > 0; i−−)
    for(j = 0; j < 6; j++)
        if(energyL[i − 1][j][sb] < energyL[i][j][idx])
            lDown++;
for(j = 0; j < 6; j++)
    if(energyLₜ₊₁[0][j][sb]< energyL[0][j][sb])
        lDown++;
for(i = 2, rUp = 0; i > 0; i−−)
    for(j = 0; j < 6; j++)
        if(energyR[i − 1][j][sb] > energyR[i][j][sb])
            rUp++;
for(j = 0; j < 6; j++)
    if(energyRₜ₊₁[0][j][sb] > energyR[0][j][sb])
        rUp++;
stThr2 = rUp + lDown;
```

where energyLₜ₊₁ and energyRₜ₊₁ are the next frame energy levels for the left and right channels, respectively.

In this exemplary embodiment of the present invention, the effect of these two sections of pseudo code is that a switch from one stereo position to the other over two consecutive frames may only be effectuated if there is a general shift in energy in the direction of the switch. The threshold upon which the decision to switch from one channel position to the other may be based upon the value of the energy threshold parameters stThr1 and stThr2.

Furthermore in this embodiment the parameter stThr1 may be viewed as a measure of the relative movement of energy from the right to the left channel over time, and vice versa the stThr2 may be viewed as a measure of the relative movement of energy from the left channel to the right over time. In accordance with the exemplary embodiment, when the stereo position image correction algorithm detects a possible change in stereo image position over two consecutive frames within a sub band, the value of the parameters stThr1 and stThr2 may be checked in order to determine that it is of sufficient magnitude to warrant the actual change.

In some embodiments of the invention the information from the next frame may not be available. For example in order to decrease the delay in encoding the encoding may be done before the next frame data has been processed.

In such embodiments of the invention the stereo image corrector 409 may determine if there are any ‘unnecessary’ changes to the stereo image position for each sub band, by following the following operation steps:

Check if the previous frame stereo position is different from the current frame stereo position. If there is a difference in positions between frames then the stereo image corrector 409 checks two energy threshold values. If the two energy thresholds are less than a predefined value, in the above example less than 12, then the stereo image corrector 409 modifies the current frame stereo position to be the same as the previous frame stereo position.

Furthermore if there is a difference in positions between frames then the stereo image corrector 409 checks if the left and right channel energies fall within a specific region of difference region. If they are within this region, which in embodiments of the invention are from unity to 1.25 times the previous frame stereo position energy value, then the stereo image corrector 409 modifies the current frame stereo position to be the same as the previous frame stereo position.

The may be represented by the following pseudocode:

```
for(sb = 0; sb < M; sb++)
{
    if(positionₜ₋₁(sb) == RightPos)
    {
        if(positionₜ(sb) == LeftPos)
        {
            if(stThr3.1 < 12 and stThr4.1 < 12)
                position(sb) = positionₜ₋₁(sb)
            else
            {
                if(eR > eL or eL < 1.25 * eR)
                    position(sb) = positionₜ₋₁(sb)
            }
        }
    }
    else if(positionₜ₋₁(sb) == LeftPos)
    {
        if(positionₜ(sb) == RightPos)
        {
            if(stThr3.2 < 12 and stThr4.2 < 12)
                position(sb) = positionₜ₋₁(sb)
            else
            {
                if(eL > eR or eR < 1.25 * eL)
                    position(sb) = positionₜ₋₁(sb)
            }
        }
    }
}
```

where positionₜ₋₁ is the previous frame stereo position of the specified sub band respectively, and stThr3.1 and stThr4.1 are the energy thresholds which may be used to determine a stationary stereo position over time.

The stThr3.1, stThr3.2, stThr4.1, stThr4.2 threshold values of 12 may be chosen as it represents that there are two time samples each with 6 adaptation levels.

The eR and eL values, in other words the relative energy values) may be calculated by summing the energy values for the currently processed sub-band, for example for the left channel the variable energyL[0][5][sb] with the neighbouring sub-band energy values energyL[0][5][sb-1] and energyL[0][5][sb+1].

The values of stThr4.1 and stThr4.2 may be calculated in the same manner as carried out previously for stThr1 and stThr2 respectively.

The energy thresholds count values stThr3.1 in other words the second right to left channel position switch check and stThr3.2 the second left to right channel position switch check respectively, may be determined by the stereo image corrector 409 by combining (averaging) the energy values from previous, current and next sub-bands and then comparing the shift or motion of the combined energy values to the current frame using the following operations:

Firstly count up the number of times over all adaptive levels where the combined energy value over the sub-band and neighbouring sub-bands for the previous frame is greater than the current energy envelope value for the potential switch channel increases from frame to frame. This is repeated with the second previous and previous channel information. This produces a first value (lUp, rUp).

Secondly count up the number of times over all adaptive levels where the combined energy value over the sub-band and neighbouring sub-bands for the previous frame decreases from frame to frame. This frame to frame comparison is done for the current frame and previous frame. This produces a second value (rDown, lDown).

Then the switch value stThr3.1 is the sum of the rDown and lUp values and stThr3.2 is the sum of the rUp and lDown values.

This may be shown in pseudocode as

```
for(i = 2, lUp = 0, lUp2 = 0; i > 0; i−−)
    for(j = 0; j < 6; j++)
    {
        div = 1;
        tmp = energyL[i − 1][j][sb];
        if(sb > 0)
        {
            div += 1;
            tmp += energyL[i − 1][j][sb − 1];
        }
        if(sb < M₁ + M₂ − 1)
        {
            div += 1;
            tmp += energyL[i − 1][j][sb + 1];
        }
        tmp /= div;
        if(tmp > energyL[i][j][sb])
            lUp++;
        if(energyL[i − 1][j][sb]> energyL[i][j][sb])
            lUp2++;
    }
for(i = 2, rDown = 0, rDown2 = 0; i > 0; i−−)
    for(j = 0; j < 6; j++)
    {
        div = 1;
        tmp = energyR[i − 1][j][sb];
        if(sb > 0)
        {
            div += 1;
            tmp += energyR[i − 1][j][sb − 1];
        }
        if(sb < M₁ + M₂ − 1)
        {
            div += 1;
            tmp += energyR[i − 1][j][sb + 1];
        }
        tmp /= div;
        if(tmp < energyR[i][j][sb])
            rDown++;
        if(energyR[i − 1][j][sb]< energyR[i][j][sb])
            rDown2++;
    }
stThr3.1 = rDown + lUp;
stThr4.1 = rDown2 + lUp2;
for(i = 2, lDown = 0, lDown2 = 0; i > 0; i−−)
    for(j = 0; j < 6; j++)
    {
        div = 1;
        tmp = energyL[i − 1][j][sb];
        if(sb > 0)
        {
            div += 1;
            tmp += energyL[i − 1][j][sb − 1];
        }
        if(sb < M₁ + M₂ − 1)
        {
            div += 1;
            tmp += energyL[i − 1][j][sb + 1];
        }
        tmp /= div;
        if(tmp < energyL[i][j][sb])
            lDown++;
        if(energyL[i − 1][j][sb]< energyL[i][j][idx])
            lDown2++;
    }
for(i = 2, rUp = 0, rUp2 = 0; i > 0; i−−)
    for(j = 0; j < 6; j++)
    {
        div = 1;
        tmp = energyR[i − 1][j][sb];
        if(sb > 0)
        {
            div += 1;
            tmp += energyR[i − 1][j][sb − 1];
        }
        if(sb < M₁ + M₂ − 1)
        {
            div += 1;
            tmp += energyR[i − 1][j][sb + 1];
        }
        tmp /= div;
        if(tmp > energyR[i][j][sb])
            rUp++;
        if(energyR[i − 1][j][sb]> energyR[i][j][sb])
            rUp2++;
    }
stThr3.2 = rUp + lDown;
stThr4.2 = rUp2 + lDown2;
and
    eL = energyL[0][5][sb];
    eR = erergyR[0][5][sb];
    if(sb > 0)
    {
        eL += energyL[0][5][sb − 1];
        eR += energyR[0][5][sb − 1];
    }
    if(sb < M₁ + M₂ − 1)
    {
        eL += energyL[0][5][sb + 1];
        eR += energyR[0][5][sb + 1];
    }
```

From the above pseudo-code it can be seen that false stereo shifting errors can be avoided in embodiments of the invention without the requirement to use the next time period data or to buffer large amounts of coded data.

It is to be understood that the stereo image corrector 409 operates in a first embodiment on a per sub band basis. However, in further embodiments of the invention the stereo image corrector 409 operates on a per region basis.

In this exemplary embodiment of the present invention the stereo image corrector 409 may further incorporate the effects of spatial auditory masking when determining the correction.

In embodiments of the invention, the stereo image corrector 409 may implement spatial auditory masking by incorporating the masking effect of previous frames onto the current frame being processed.

In one such embodiment of the invention the stereo image corrector 409 checks whether the previous frame stereo position was left or right. If the previous frame stereo position was in one channel and if the other channel energy envelope for the previous or the second previous frame is greater than a multiple (g1) of the one channel energy envelope then the stereo image corrector 409 fixes the current frame stereo position to be that of the previous one. Furthermore if the average (of the two channels (L+R)/2) channel energy envelope for the previous frame is significantly greater than the average channel energy envelope for the current frame (in embodiments of the invention as shown below this can be a factor of 8) then the stereo image corrector 409 also fixes the current frame stereo position to be that of the previous one.

This may be represented as the following pseudo code;

```
for(sb = 0; sb < M; sb++)
{
    if(positionₜ₋₁(sb) == RightPos)
    {
        /*
        * Left channel energy of t−1 frame masks the
right channel of this frame t.
        */
        if(energyL[1][4][sb] > g1 * energyR[0][4][sb])
            position(sb) = positionₜ₋₁(sb)
        /*
        * Left channel energy of t−2 frame masks the
right channel of this frame t.
        */
        else if(energyL[2][4][sb] > g1 *
energyR[0][4][sb])
            position(sb) = positionₜ₋₁(sb)
    }
    else if(positionₜ₋₁(sb) == LeftPos)
    {
        /*
        * Right channel energy of t−1 frame masks the
left channel of this frame t.
        */
        if(energyR[1][4][sb] > g1 * energyL[0][4][sb])
            position(sb) = positionₜ₋₁(sb)
        /*
        * Right channel energy of t−2 frame masks the
left channel of this frame t.
        */
        else if(energyR[2][4][sb] > g1 *
energyL[0][4][sb])
            position(sb) = positionₜ₋₁(sb)
    }
    /*
    * Mono channel energy of t−1 frame masks the mono
channel of this frame t.
    */
    else if(sum1 > 8.0 * sum0)
        position(sb) = positionₜ₋₁(sb)
}
```

where sum0 and sum1 are calculated as follows

sum0=(energyL[0][4][sb]+energyR[0][4][sb])·0.5

sum1=(energyL[1][4][sb]+energyR[1][4][sb])·0.5

The stereo image corrector 409 operating the above pseudo code in embodiments of the invention therefore implements time based masking for each sub band. In other words high energy values from previous frames may be assumed to mask the current frame if the energy difference between channels is above a pre-determined threshold. The masking may have the effect of distorting the metrics for the current frame upon which the image position decision is based on.

This masking effect may be further explained in the context of a stereo channel pair. For example the energy within a sub band of the left channel from a previous frame may contribute to the energy measurement when determining the stereo image position for the current frame. This contribution may have the effect of biasing the decision in favour of selecting an image position for the current frame.

In other words the energy contribution from a previous frame left channel may mask a right channel decision for the current frame. In embodiments of the invention the masking problem may be counteracted by checking that the ratio of the left channel energy level from a previous frame to the right channel energy of the current frame is not above a pre-determined threshold. If the pre-determined threshold is reached then the stereo image corrector 409 may indicate that the current frame image position decision has been masked by a previous frame and the stereo image corrector 409 correct the decision to output a ‘right channel’ decision. Similarly the stereo image corrector 409 may operate to correct the decision where a previous frame right channel energy masks a left channel decision for a current frame.

This stereo image corrector 409 may further perform the masking check only when the outcome would result in the current image position value being the same as the image position value from the previous frame. This further option has the added advantage of biasing the decision in the favour of maintaining a continuous image position track from one frame to the next. Referring to the previous example shown above the check may only be performed if the image position for the previous frame was determined as a right channel.

In the exemplary embodiment of the invention the energy values used for each sub band were those obtained from the energy spectral envelope tracker 405 algorithm. This is depicted by the pseudo code section shown above. However, it is to be understood that further embodiments of the invention may use different energy metrics.

Furthermore, the pre-determined threshold g1 shown above in the pseudo code may in embodiments be 4.0. This value has been experimentally determined to produce an advantageous result. However, further embodiments of the invention may use different values for the factor g1.

The stereo image corrector 409, may in further embodiments of the present invention also include the effects of frequency based masking in addition to or instead of time based masking when determining the stereo image position correction factor. Frequency based masking may be realised by taking into account the energy of frequency components within a sub band and modelling the masking effect this has across neighbouring sub bands. This masking effect may be modelled as a straight line in the frequency domain. The slope of the line is partly determined such that the masking effect decreases in a linear manner with increasing distance of the masked sub bands from the masking sub band. The masking effect of a sub band may then be projected across all neighbouring sub bands, by extending the effect of masking across the said sub bands. This may be done for both higher and lower frequencies, where the gradient of the masking effect extending in the direction of higher frequencies may be negative, and the gradient of the masking effect extending in the direction of lower frequencies (or sub bands) may be positive. The cumulative effect of frequency masking by neighbouring sub bands on a particular sub band, may be represented by summing the masking energies of all those sub bands whose masking profiles overlap with the particular sub band.

The stereo image corrector 409 may use frequency domain masking. For example in an embodiment of the invention the stereo image corrector 409 may define a logarithmic (dB) representation of the average of the two channels energy values.

For example a masking operation may be carried out by the stereo image corrector 409 with the following pseudo code:

```
for(sb = 0; sb < M; sb++)
{
    tmp = (energyL[0][5][sb] + energyR[0][5][sb]) * 0.5;
    eLevels[sb] = 10 * log10(tmp);
    difA[sb] = 0;
}
/*
* Masking slope towards higher frequencies.
*/
for(sb = 0; sb < M; sb++)
{
    for(j = 0; j < sb; j++)
    {
        startLevel = eLevels[j];
        for(k = j; k < sb; k++)
        {
            startLevel −= g3;
            if(startLevel < 0)
                startLevel = 0;
        }
        /*-- Subband is masked by other subbands. --*/
        if(startLevel > eLevels[sb])
            difA[sb] = 1;
    }
}
/*
* Masking slope towards lower frequencies.
*/
for(sb = M − 1; sb >= 0; sb−−)
{
    for(j = M − 1; j >= sb; j−−)
    {
        startLevel = eLevels[j];
        for(k = j; k > sb; k−−)
        {
            startLevel −= g4;
            if(startLevel < 0)
                startLevel = 0;
        }
        /*-- Subband is masked by other subbands. --*/
        if(startLevel > eLevels[sb])
            difA[sb] = 1;
    }
}
for(sb = 0; sb < M; sb++)
    if(difA[sb])
        position(sb) = positionₜ₋₁(sb)
```

The stereo image corrector 409 frequency domain masking scheme, as exemplary described by the above section of pseudo code, may be implemented as part of a stereo image correction scheme. The stereo image corrector 409 may use frequency domain masking in order to bias the stereo image position in favour of being the same position from one frame to the next on a per sub band basis.

The frequency domain masking may be achieved by determining the accumulated masking energy within a sub band. If the accumulated masking energy level is high enough then it is deemed that the sub band has been masked by other sub bands within the same frame. In this situation the stereo image corrector 409 fixes the current frame stereo image position for the sub band to the previous frame stereo image position value.

In some embodiments of the present invention the stereo image corrector 409 may use a different gradient for masking slopes extending towards the higher frequencies from masking slopes extending towards the lower frequencies. Further, the values of the gradient factors may be determined from listening tests using experimental data. For example, a suitable value of gradient for masking slopes extending towards both higher frequencies and lower frequencies has been found to be 6.0. Further still, the values of the gradient factors may be determined from a psychoacoustic scale.

Furthermore, the stereo image corrector 409 frequency masking scheme as exemplary depicted by the section of pseudo code shown above is determined using energy values based on a decibel or logarithmic scale. It is to be understood that further embodiments of the invention may utilise energy values based upon a different scale such a linear scale.

The Stereo image correction process is shown by step 611 in FIG. 6.

The channel outputs of the energy converter 403, may also be additionally connected to the input of the stereo image gain (or stereo level) calculator 411.

The stereo image gain calculator 411 uses the energy converter 403 outputs for both channels to determine the stereo image gain values according to the following set of equations:

$$gain ( i ) = \frac{max ( g {Level}_{L} ( i ) , {gLevel}_{R} ( i ) )}{min ( {gLevel}_{L} ( i ) , {gLevel}_{R} ( i ) )} , 0 \leq i < K$$

$${gLevel}_{L} ( i ) = \sqrt{\frac{{g}_{L} ( i )}{( {g}_{L} ( i ) + {g}_{R} ( i ) )}}$$

$${gLevel}_{R} ( i ) = \sqrt{\frac{{g}_{R} ( i )}{( {g}_{L} ( i ) + {g}_{R} ( i ) )}}$$

$${g}_{L} ( i ) = {\sum }_{j = {offset}_{2} [ i ]}^{{offset}_{2} [ i + 1 ] - 1} {e}_{L} ( i )$$

$${g}_{R} ( i ) = {\sum }_{j = {offset}_{2} [ i ]}^{{offset}_{2} [ i + 1 ] - 1} {e}_{R} ( i )$$

where offset₂ is the frequency offset table describing the frequency bin offsets for each spectral sub band, K is the number of spectral gain sub bands present in the region, and max( ) and min( ) return the maximum and minimum of the specified samples, respectively.

The gain values calculated by the stereo image gain calculator 411 may be used in association with the corrected stereo image position value determined by stereo image position tracker 407 and stereo image position corrector 409. Thus in embodiments of the invention each stereo image position value has an accompanying stereo image gain value.

The process of determining the stereo image gain is shown by step 613 in FIG. 6.

The output of the stereo image gain calculator 411 may then be connected to the input of the stereo image gain quantizer 413. The stereo image gain quantizer 413 applies a quantization on the stereo image gain values for all sub bands within the region being processed on a frame by frame basis.

In an exemplary embodiment of the present invention a different quantisation scheme may be applied by the stereo image gain quantizer 413 of the region encoder depending on which region is being processed. Thus a first quantization algorithm may be used in the 1st region encoder 250 processing the lower frequency region and a second quantization algorithm may be used in the 2nd region encoder 260 processing the higher frequency region.

For example the stereo image gain quantizer 413 may operate for a 1st region encoder 250 a scalar quantization scheme, consisting of calculating the mean square error between the stereo image gain value and each entry in a quantization table, and then selecting the quantisation table entry which is found to minimise the mean square error, the index into the table being the representation of the quantized value. This is performed on a per sub band basis. Furthermore, if the proceeding sub band is found to have a quantization index which indicates little or no gain value then a smaller quantization table may be used for the stereo image gain following it. Otherwise a larger quantization table may be used to quantize the stereo image gain for each sub band. For example, in the exemplary embodiment of the invention the index of the smaller quantization table may be represented with two bits, and the index of the larger table with four bits. The two and four bit quantization tables may be generated from the following equations:

Q_{2-bits}(f)=2^{0.25·f},0≦i<4

Q_{4-bits}(f)=2^{0.25·f},0≦i<16

In some embodiments the stereo image gain quantizer 413 may operate in the 2nd region encoder 260 a sub band stereo level gain quantization scheme taking the same form as that described for the 1st region encoder 250 stereo image gain quantizer 413.

It is to be understood that the second region may represent higher based frequencies, which when compared to lower frequencies, the stereo image gains tend to have a smaller dynamic range. Thus, in an embodiment of the present invention the stereo image gains for the higher frequency region may be quantised using a smaller quantization table. For example, in the exemplary embodiment of the invention a 3 bit quantization table may be preferred over a 4 bit quantization table for region 2 quantization.

The stereo image gain quantizer 413 may, once all sub band stereo image gains have been quantized, perform a check for each sub band for frames which have used the large quantization table to quantize the stereo image gains. This check may be used in order to determine if the stereo image gain quantizer 413 uses either just the top or bottom half of the quantization table, and therefore determine if the quantization indices can be represented using fewer bits. The stereo image gain quantizer 413 may insert a signalling bit into the bitstream in order to indicate that the stereo gain indices for each sub band within the frame are each quantized with fewer bits. However, if the full range of the quantization table is used for the current frame, then the stereo image gain quantizer 413 may not set the signalling bit.

It is to be noted that further embodiments of the invention may use vector quantization techniques in order to represent stereo image gains for each region. It is to be further understood that the same techniques as described above can be applied to most vector quantization schemes.

The process of stereo image gain quantization is shown by step 615 in FIG. 6.

The region encoder 250, 260 is configured to output a stereo image position value and a quantized stereo image gain for each sub band via the outputs 415 and 417 respectively. The quantized stereo image gain values are passed directly to the bit stream formatter (Multiplexer) 280.

This outputting of the quantized stereo image gain values is shown as step 617 in FIG. 6.

The stereo image position for each sub band may be passed to the Stereo image post processor 270.

This outputting of the stereo image position value to the stereo image pose processor 270 is shown as step 619 in FIG. 6.

Additionally the energy values used in the spectral energy envelope tracker 405 are also passed via the region coder output 418 to the stereo image position post processor 270.

The outputting of spectral energy envelope tracker 405 energy values is depicted as step 621 in FIG. 6.

In the exemplary embodiment of the invention parameters and values may be passed from all region encoders into the stereo image post processor 270 and the bit formatter 280.

The stereo image post processor 270 corrects the stereo image position profile such that it is biased in favour a smooth and continuous profile over time. The stereo image post processor 270 may perform the post processing by comparing, for each sub band, the current frame stereo image position with the immediate previous frame and the immediate successive frame stereo image positions for the same sub band.

The stereo image post processor 270 performs this operation in order to determine if the current frame stereo image position is different from the previous and successive frame's stereo image position. If the current frame stereo image position is different from the previous and successive frame's stereo image position then the stereo image post processor 270 calculates an energy factor which is dependent on the relative difference of the energies between the sub band of the current frame, and the sub bands of the previous and successive frames.

If the current frame stereo image position is different from the previous and successive frame's stereo image position by a factor above a threshold value, then the stereo image post processor 270 may change the stereo image position for the sub band to the same value as the adjoining previous and successive frames.

Furthermore, in some embodiments of the present invention the stereo image post processor 270 may operate this process to both frequency regions. This may be achieved in embodiments of the invention by the combining of region 1 with region 2, and performing processing on the basis of a single combined region. The detection of stereo image position movement and correction may be implemented in accordance with the following pseudo code:

```
for(i = 1; i < M₁ + M₂ − 1; i++)
{
    if(position[i − 1] == position[i + 1] &&
position[i] != position[i − 1])
    {
        if(position[i − 1] == RightPos)
        {
            eR = 10*log10(energyR[0][5][i − 1] +
energyR[0][5][i + 1]);
            eL = 10*log10(energyL[0][5][i]);
            if(eR − eL > 3.0)
                position[i] = position[i − 1];
        }
        else if(position[i − 1] == LeftPos)
        {
            eL = 10*log10(energyL[0][5][i − 1] +
energyL[0][5][i + 1]);
            eR = 10*log10(energyR[0][5][i]);
            if(eL − eR > 3.0f)
                position[i] = position[i − 1];
        }
    }
}
```

In some embodiments of the present invention the stereo image post processor 270 may comprise determine if all the sub bands within a frame should be corrected to be the same stereo image position value. The stereo image post processor 270 may carry out this operation when a majority of the sub bands have the same image position value, and a minority of sub bands have a different value may be set to the same value as the majority. The stereo image post processor 270 may carry out this majority correction for each region individually, or as a combination of both or multiple regions. The stereo image post processor 270 performing the majority correction scheme may be implemented in accordance with the following pseudo code:

```
stCount[0] = stCount[1] = 0;
for(i = 0; i < M₁ + M₂; i++)
    stCount[(position[i] == LeftPos) ? 0 : 1] += 1;
if(stCount[0] >= M₁ + M₂ − 2)
{
    for(i = 0; i < M₁ + M₂; i++)
        position [i] = LeftPos;
}
else if(stCount[1] >= M₁ + M₂ − 2)
{
    for(i = 0; i < M₁ + M₂; i++)
        position [i] = RightPos;
}
else
{
    stCount[0] = stCount[1] = 0;
    for(i = 0; i < M₁; i++)
        stCount[(position[i] == LeftPos) ? 0 : 1] += 1;
    if(stCount[0] >= M₁ − 3)
    {
        for(i = 0; i < M₁; i++)
            position [i] = LeftPos;
    }
    else if(stCount[1] >= M₁ − 3)
    {
        for(i = 0; i < M₁; i++)
            position [i] = RightPos;
    }
    stCount[0] = stCount[1] = 0;
    for(i = 0; i < M₁ + M₂; i++)
        stCount[[(position[i] == LeftPos) ? 0 : 1] += 1;
    if(stCount[0] >= M₁ + M₂ − 1)
    {
        for(i = 0; i < M₁ + M₂; i++)
            position[i] = LeftPos;
    }
    else if(stCount[1] >= M₁ + M₂ − 1)
    {
        for(i = 0; i < M₁ + M₂; i++)
            position[i] = RightPos;
    }
}
```

In further embodiments the stereo image post-processor 270 may be combined with the previous stereo image correction process as carried out in the stereo image corrector 409 of the region encoder 250, 260.

The step of stereo image post processing is shown as 511 in FIG. 5.

The stereo image post processor 270 may then encode the stereo image value. In an exemplary embodiment of the invention the encoding of the stereo image value may take the form of using a single bit to encode the image position associated with each sub band, which may be implemented according to the following section of pseudo code:

```
for(sb = 0; sb < M₁ + M₂; sb++)
{
    if(position[sb] == LeftPos)
        Send ‘1’ bit
    else
        Send ‘0’ bit
}
```

where M₁ and M₂ are the number of position sub bands for the first and second region respectively.

In further embodiments of the invention the stereo image post processor may insert an extra signalling bit to the bit stream on a frame by frame basis. This bit may be used to indicate if the current frame's stereo image positions are the same as the previous frame's stereo image position. If this is the case, then there no sub band stereo image position information may be distributed to the bit stream.

Encoding of the stereo image positions is shown as step 513 in FIG. 5.

The bitstream formatter 280 may receive as an input the encoded stereo image position bit stream output from the stereo image post processor 270, the quantized stereo image gain values from each of the region encoders 250 and 260, and the encoded output from the mono channel audio coder.

The bitstream formatter may format the encoded stereo image position bit stream output from the stereo image post processor 270, the quantized stereo image gain values from each of the region encoders 250 and 260, and the encoded output from the mono channel audio coder to produce the bitstream output.

The bitstream formatter 280 in some embodiments of the invention may interleave the received inputs and may generate error detecting and error correcting codes to be inserted into the bitstream output 112.

The process of bitstream formatting is shown as step 515 in FIG. 5.

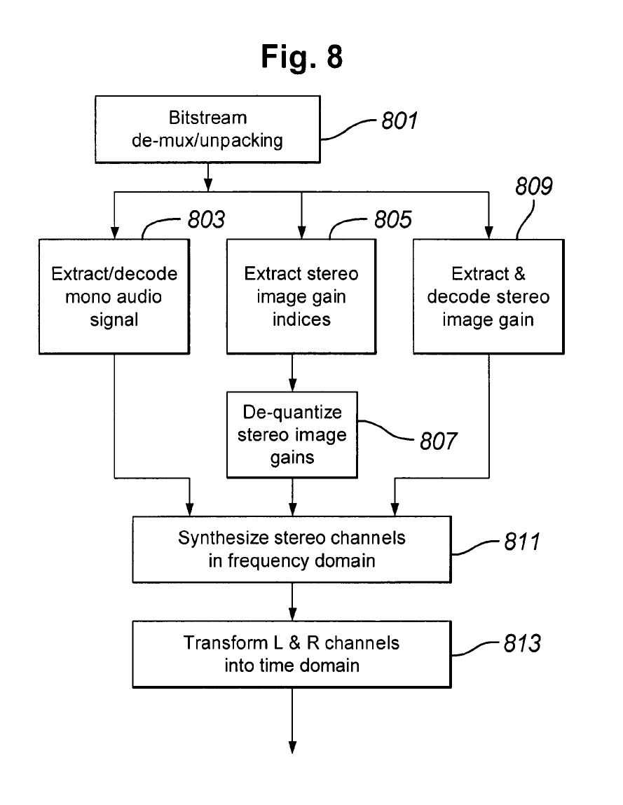

To further assist the understanding of the invention the operation of the decoder 108 with respect to the embodiments of the invention is shown with respect to the decoder schematically shown in FIG. 7 and the flow chart showing the operation of the decoder in FIG. 8.

The decoder comprises an input 313 from which the encoded bitstream 112 may be received. The input 313 is connected to the bitstream unpacker 301.

The bitstream unpacker 301 demultiplexes, partitions, or unpacks the encoded bitstream 112 into at least two separate bitstreams. The mono encoded audio bitstream is passed to the mono audio decoder 303, the extracted stereo extension bitstream is passed to the stereo image gain extractor 305 and the stereo image position extractor 307.

This unpacking process is shown in FIG. 8 by step 801.

The mono audio decoder 303 receives the mono audio encoded data and constructs a synthesised audio signal by performing the inverse process to that performed in the mono audio encoder 240. This may be performed on a frame by frame basis. It is to be noted that the output from a typical mono audio decoder is a time domain based signal.

This audio decoding process of the mono audio signal is shown in FIG. 8 by step 803.

In an exemplary embodiment of the invention the time domain signal may then be converted into a frequency domain based representation by a time to frequency transformer 309. The time to frequency domain transformer may use a modified discrete cosine transform (MDCT). The output from the time to frequency domain transformer 309 may then be connected to the stereo synthesiser 319. In this exemplary embodiment of the invention stereo synthesis may be performed in the MDCT domain. It is to be understood that in some embodiments of the invention, stereo synthesis may be performed in other frequency domain representations of the signal, which are obtained as a result of a discrete orthogonal transform. A list of non limiting examples of the transform applied by the time to frequency domain transformer 309 may include discrete fourier transform (DFT), discrete cosine transform (DCT), and discrete sine transform (DST).

In further embodiments of the invention the output from the mono audio decoder 303 may be a frequency domain representation of the signal. In these further embodiments of the invention no time to frequency domain conversion is required and the output from the mono audio decoder 303, may be connected directly to the stereo synthesiser 319. Thus, in some embodiments the time to frequency domain transformer 309 may be omitted.

The image gain extractor 305 may be arranged to receive the stereo extension encoded data. Upon receiving the stereo extension data the image gain extractor extracts quantized stereo image gain parameters for all sub bands. This is typically performed in embodiments of the invention on a frame by frame basis. The image gain extractor 305 may in the exemplary embodiment of the invention read the region number bit first. The image gain extractor 305 may read the region number/indicator bit(s) in order to determine the region for which the subsequent quantized gain indices belong. If after inspection by the image gain extractor 305 that the region bit indicates that the subsequent stereo image gain indices are assigned to a first region, then the image gain extractor 305 may determine if there is a further signalling bit embedded within the bit stream. This further signalling bit may be used by the image gain extractor 305 to indicate that any subsequently received indices for the region is formed by considering a sub set of the full quantization table.

For example using the encoding methods described above, the further signalling bit may indicate that subsequent gains are to be decoded using 3 bits rather than the full quantization table size of 4 bits.

However, in the same example where the image gain extractor 305 determines that the region bit indicates that subsequent stereo image gain indices belong to a second region, then each index may have been selected using the full length of the quantization table.

The image gain extractor 305 may, whilst extracting the stereo image gains for a sub band, monitor a proceeding sub band gain index to ascertain if it has a value which indicates a zero gain value. Where the image gain extractor 305 determines a zero gain then the sub band which is currently being de-quantized may have a stereo image gain value index formed from a reduced size quantization table.

The image gain extractor 305 may perform gain extraction according to the exemplary embodiment of the invention using the following pseudo code:

| | |
|---|---|
| Region 1: | |
| 3_4_signaling_bit | 1-bit |
| for(j = 0; j < K₁; j++) | |
| { | |
| if(idxₜ₋₁[j] == 0) | |
| x = 2; | |
| else if(3_4_signaling_bit == ‘1’) | |
| x = 3; | |
| else | |
| x = 4; | |
| idxₜ[j] | x-bits |
| } | |
| Region 2: | |
| for(j = 0; j < K₂; j++) | |
| { | |
| if(idxₜ₋₁[K₁ + j] == 0) | |
| x = 2; | |
| else | |
| x = 3; | |
| idxₜ[K₁ + j] | x-bits |
| } | |

where K₁ and K₂ are the number of gain sub bands for the first and second region, respectively, and idxₜ₋₁ is the extracted gain index from previous frame.

The process of extraction of the stereo image gain indices is shown in FIG. 8 by step 805.

The stereo image level gain extractor 305 may then de-quantise the indices associated with the stereo image level gains. Furthermore, the stereo image level gain extractor 305 may then expand the stereo image level gains to follow the structure of the sub bands for subsequent stereo image positioning. According to the exemplary embodiment of the invention de-quantisation of the gain indices and their subsequent expansion may be represented by the following equations

gain(i)=2^{0.25·idx}^{₁}^{[i]},0≦i<K₁

gain(K₁+i)=2^{0.5·idx}^{₁}^{[K}^{₁}^{+i]},0≦i<K₂

gainLR(i)=gain(└i/2┘),0≦i<2·K₁

gainLR(2·K₁+i)=gain(K₁+i),0≦i<K₂

De-quantisation of the stereo image gains and the mapping of the subsequent gain values to the sub band structure is shown as step 807 in FIG. 8.

The stereo image position extractor 307 is arranged such that on receiving the stereo extension encoded data it may extract the encoded stereo image position information for the sub bands from the bitstream. This is typically performed on a frame by frame basis. In the exemplary embodiment of the invention the stereo image positions are extracted by first reading the signalling bit in order to ascertain if the previous frame stereo image position should be used for the current frame. If the signalling bit indicates that the stream contains stereo image position information for the current frame, then the stereo image position for each spectral sub band is read according to the following equation:

$$pos ( i ) = \{ \begin{matrix}new\_pos ( i ) , & pos\_sig \_bit = {}_{}^{‵}{0}{}_{}^{′} \\ {pos}_{t - 1} ( i ) , & otherwise ,\end{matrix} 0 \leq i < {M}_{1} + {M}_{2} \\ new\_pos ( i ) = \{ \begin{matrix}LeftPos , & bit\_value ( i ) == {}_{}^{‵}{1}{}_{}^{′} \\ RightPos , & otherwise\end{matrix}$$

Where M₁ and M₂ are the number of position sub bands for the first and second region, respectively, and posₜ₋₁ is the stereo position of the previous frame. Otherwise the previous frame's stereo image position may be used for the current frame. This may be done for all encoded regions.

The process of decoding the stereo image position information from the bit stream is shown as step 809 in FIG. 8.

The stereo synthesiser 319 is arranged to receive the stereo image gain values from the image gain extractor 305 and the stereo image position values from the position extractor 307 for each sub band per frame, and frequency domain based coefficients representing the mono audio signal from the time to frequency transformer 309 (or the mono audio decoder 303). In the exemplary embodiment of the invention the frequency domain based coefficients are modified discrete cosine transform (MDCT) coefficients.

The stereo synthesiser 319 is configured to synthesise the two channel signals (left and right) channel for each sub band using the received information. In the exemplary embodiment of the invention the synthesis of the channel signals may be achieved according to the following pseudo code:

```
          for (sb = 0; sb < M₁ + M₂; sb++)
          {
            if (gainLR[sb] > gainLRₜ₋₁[sb] &&
          pos[sb] != posₜ₋₁[sb])
            {
              tmp = (gainLR[sb] + gainLRₜ₋₁[sb]) · 0.5 ;
              gainLRₜ₋₁[sb] = gainLRₜ₋₁[sb];
              gainLR[sb] = tmp;
            }
            else
              gainLRₜ₋₁[sb] = gainLR[sb]
            $\begin{matrix}gain 0 = gainLR [ sb ] ; \\ gain 2 = \frac{2}{1.0 + gainLR [ sb ]} ;\end{matrix}$
            if (pos [i] == LeftPos)
              for (j = offset [sb]; j < offset [sb + 1];
          j++)
              {
                R_{f} (j) = M_{f} (j) · gain2;
                L_{f} (j) = R_{f} (j) · gain0;
              }
            else
              for(j = offset [sb]; j < offset [sb + 1];
          j++)
              {
                L_{f} (j) = M_{f} (j) · gain2;
                R_{f} (j) = L_{f} (j) · gain0;
              }
          }
```

where offset is the frequency offset table describing the frequency bin offsets for each spectral sub band. This table combines the offset tables of the 1^{st} and 2^{nd} regions. M_{f} is the MDCT transformed decoded mono signal, and L_{f} and R_{f} are the synthesised left and right channels, respectively.

The process of synthesising the two channels of the audio signal is shown as step 811, in FIG. 8.

Once the left and right channels have been synthesised, they may be transformed into time domain channels by performing the inverse of the unitary transform used to transform the signal into the frequency domain carried out in the encoder. In the exemplary embodiment of the invention this may take the form of an inverse modified discrete transform (IMDCT) as depicted by frequency to time transformers 313 and 315.

The process of transforming the two channels (stereo channel pair) is shown as step 813, in FIG. 8.

It is to be understood that even though the present invention has been exemplary described in terms of a stereo channel pair, it is to be understood that the present invention may be applied to further channel combinations. For example the present invention may be applied to a two individual channel audio signal. Further, the present invention may also be applied to multi channel audio signal which comprises combinations of channel pairs such as the ITU-R five channel loudspeaker configuration known as 3/2-stereo. Details of this multi channel configuration can be found in the International Telecommunications Union standard R recommendation 775. The present invention may then be used to encode each member pair of the multi channel configuration.

The embodiments of the invention described above describe the codec in terms of separate encoders 104 and decoders 108 apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some/or all common elements.

Although the above examples describe embodiments of the invention operating within a codec within an electronic device 610, it would be appreciated that the invention as described below may be implemented as part of any variable rate/adaptive rate audio (or speech) codec. Thus, for example, embodiments of the invention may be implemented in an audio codec which may implement audio coding over fixed or wired communication paths.

Thus user equipment may comprise an audio codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof.

For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-80. (canceled)

81. A method comprising:
transforming each of the at least two channels of the audio signal into a frequency domain representation, the frequency domain representation comprising at least one group of spectral coefficients;
calculating a first relative energy value of at least one of the at least one group of spectral coefficients for a first channel of the at least two channels;
calculating a second relative energy value of at least one of the at least one group of spectral coefficients for a second channel of the at least two channels;
determining the at least one audio signal image position value further by comparing the second relative energy level to the first relative energy level; wherein the at least one audio signal image position value is dependent on the comparing of the second relative energy level to the first relative energy level; and
calculating at least one audio signal image gain value associated with the at least one audio signal image position value by determining the ratio of a maximum: of the first relative energy level; and the second relative energy level, to a minimum of: the first relative energy level; and the second relative energy level.

82. The method as claimed in claim 81 wherein the audio signal image position value for the at least one region is configured to identify a first channel if the first relative energy level is greater than the second relative energy level, and wherein the audio signal image position value for the at least one region is configured to identify a second channel if the second relative energy level is greater than the first relative energy level.

83. The method as claimed in claim 81, further comprising:
quantizing the at least one audio signal image gain for the at least one group using at least one of at least two quantisation tables, wherein quantizing further comprises;
selecting one of a first quantisation table or a second quantisation table from the at least two quantisation tables, wherein the selection of the first quantisation table is dependent on an audio signal image gain from a proceeding time period being quantized with a first predetermined index, and wherein the selection of the second quantisation table is dependent on the audio signal image gain from a proceeding sub band being quantized with a second predetermined index.

84. The method as claimed in claim 81, further comprising:
generating a first energy function from a sequence of the calculated first relative energy values; wherein each value of the first energy function is dependent on the calculated first relative energy values for a predefined time period and
further generating a second energy function from a sequence of the calculated second energy values, wherein each value of the second energy function is dependent on the calculated second relative energy values for a predefined time period, wherein the audio signal image position value is further dependent on the first energy function values and the second energy function values.

85. The method as claimed in claim 84, wherein the audio signal image position value for a first instant is dependent on at least two of the first energy function values and the second energy function values.

86. The method as claimed in claim 84, wherein determining the audio signal image position value comprises:
determining a first audio signal image position value for a current time period dependent on the calculated first and second relative energy values for the current time period;
correcting the first audio signal image position value dependent on the relative magnitudes of the first and second energy function values.

87. The method as claimed in claim 84, the method further comprising:
determining a level of frequency domain masking for the group;
comparing the level of frequency domain masking against a threshold for the at least one group, wherein the audio signal image position value is further dependent on comparison result of the level of frequency domain masking against a threshold for the at least one group.

88. The method as claimed in claim 87, wherein the determining of a level of frequency domain masking for the at least one group further comprises:
calculating a further relative energy value of at least one other group in the same time period of the audio signal;
determining a proportion of the energy value contribution of the at least one other group distributed to the at least one group using a shaping function; and
comparing the proportion of the value of the energy value contribution of the at least one other group to a threshold value.

89. The method as claimed in claim 84, wherein the energy function is an exponential average gain estimator type function, and wherein the magnitude of a leakage factor of the exponential average gain estimator is varied within a group.

90. A method comprising:
receiving an encoded signal comprising at least in part an audio signal image position signal and an audio signal image gain level signal, wherein the audio signal comprises a plurality of groups of spectral coefficients;
determining at least one audio signal image gain value from the received audio signal image gain signal by determining at least one audio signal image gain value for each one of the plurality of groups of spectral coefficients;
determining at least one audio signal image position value from the received audio signal image position signal by determining at least one audio signal image position value comprises determining at least one audio signal image position value for each one of the plurality of groups of spectral coefficients;
decoding from at least part of the encoded signal a mono synthetic audio signal; and
generating at least two channels of audio signals dependent on the mono synthetic audio signal, the received audio signal image gain signal, and the audio signal image position signal.

91. The method as claimed in claim 90 wherein generating at least two channels of audio signals further comprises:
generating at least two channel gains dependent on the audio signal image position value and the at least one audio signal image gain level value, wherein at least one channel gain is associated with a first of the at least two channels of audio signals, and a further channel gain is associated with a second of the at least two channels of audio signals;
generating a first of the at least two channels of audio signals by multiplying the mono synthetic signal with the at least one channel gain associated with the first channel; and
generating a second of the at least two channels of audio signals by multiplying the mono synthetic signal with the further channel gain associated with the second channel.

92. The method as claimed in claim 90, wherein generating at least two channels of audio signals further comprises transforming the first and second of at least two channels of audio signals into the time domain by a frequency to time domain transformation.

93. The method as claimed in claim 90, wherein the determining at least one audio signal image gain value further comprises:
reading at least one audio signal image gain index from the gain level signal;
selecting one of at least two quantization functions by selecting the first quantization function if the at least one audio signal image gain index for a previous frame has a first predetermined index value;
generating the at least one audio signal image gain value dependent on the at least one audio signal image gain index and the one of at least two quantization functions selected.

94. The method as claimed in claim 93, wherein the selecting one of at least two quantization functions further comprises selecting a second of the at least two quantization functions if the at least one audio signal image gain index for a previous frame has a second predetermined index value.

95. The method as claimed in claim 94, wherein the first predetermined index value is zero and the second predetermined index value is a non zero value.

96. The method as claimed in claim 90, wherein the mono audio signal is a time domain signal, and wherein the method further comprises:
transforming the time domain mono audio signal to a frequency domain mono audio signal.

97. An apparatus comprising at least one processor and at least one memory including computer program code the at least one memory and the computer program code configured to, with the at least one processor, cause the apparatus at least to:
transform each of the at least two channels of the audio signal into a frequency domain representation, the frequency domain representation comprising at least one group of spectral coefficients;
calculate a first relative energy value of at least one of the at least one group of spectral coefficients for a first channel of the at least two channels;
calculate a second relative energy value of at least one of the at least one group of spectral coefficients for a second channel of the at least two channels;
determine the at least one audio signal image position value further by comparing the second relative energy level to the first relative energy level; wherein the at least one audio signal image position value is dependent on the comparing of the second relative energy level to the first relative energy level; and
calculate at least one audio signal image gain value associated with the at least one audio signal image position value by determining the ratio of a maximum: of the first relative energy level; and the second relative energy level, to a minimum of: the first relative energy level; and the second relative energy level.

98. The apparatus as claimed in claim 97, wherein the audio signal image position value for the at least one region is configured to identify a first channel if the first relative energy level is greater than the second relative energy level, and wherein the audio signal image position value for the at least one region is configured to identify a second channel if the second relative energy level is greater than the first relative energy level.

99. The apparatus as claimed in claim 97 wherein the at least one memory and the computer program code are further configured to, with the at least one processor, cause the apparatus at least to:
quantize the at least one audio signal image gain for the at least one group using at least one of at least two quantisation tables, wherein quantizing further comprises; and
select one of a first quantisation table or a second quantisation table from the at least two quantisation tables, wherein the selection of the first quantisation table is dependent on an audio signal image gain from a proceeding time period being quantized with a first predetermined index, and wherein selection of the second quantisation table dependent on the audio signal image gain from a proceeding sub band being quantized with a second predetermined index.

100. The apparatus as claimed in claim 97, wherein the at least one memory and the computer program code are further configured to, with the at least one processor, cause the apparatus at least to:
generate a first energy function from a sequence of the calculated first relative energy values; wherein each value of the first energy function is dependent on the calculated first relative energy values for a predefined time period and
further generate a second energy function from a sequence of the calculated second energy values, wherein each value of the second energy function is dependent on the calculated second relative energy values for a predefined time period, wherein the audio signal image position value is further dependent on the first energy function values and the second energy function values.

101. The apparatus as claimed in claim 100, wherein the audio signal image position value for a first instant is dependent on at least two of the first energy function values and the second energy function values.

102. The apparatus as claimed in claim 100, wherein the at least one memory and the computer program code are further configured to, with the at least one processor, cause the apparatus at least to:
determine a first audio signal image position value for a current time period dependent on the calculated first and second relative energy values for the current time period; and
correct the first audio signal image position value dependent on the relative magnitudes of the first and second energy function values.

103. The apparatus as claimed in claim 100, wherein the at least one memory and the computer program code are further configured to, with the at least one processor, cause the apparatus at least to:
determine a level of frequency domain masking for the group;
compare the level of frequency domain masking against a threshold for the at least one group, wherein the audio signal image position value is further dependent on comparison result of the level of frequency domain masking against a threshold for the at least one group.

104. The apparatus as claimed in claim 103, wherein the at least one memory and the computer program code are further configured to, with the at least one processor, cause the apparatus at least to:
calculate a further relative energy value of at least one other group in the same time period of the audio signal;
determine a proportion of the energy value contribution of the at least one other group distributed to the at least one group using a shaping function; and
compare the proportion of the value of the energy value contribution of the at least one other group to a threshold value.

105. The apparatus as claimed in claim 100, wherein the energy function is an exponential average gain estimator type function, and wherein the magnitude of a leakage factor of the exponential average gain estimator is varied within a group.

106. An apparatus comprising at least one processor and at least one memory including computer program code the at least one memory and the computer program code configured to, with the at least one processor, cause the apparatus at least to:
receive an encoded signal comprising at least in part an audio signal image position signal and an audio signal image gain level signal, wherein the audio signal comprises a plurality of groups of spectral coefficients;
determining at least one audio signal image gain value from the received audio signal image gain signal by determining at least one audio signal image gain value for each one of the plurality of groups of spectral coefficients;
determining at least one audio signal image position value from the received audio signal image position signal by determining at least one audio signal image position value comprises determining at least one audio signal image position value for each one of the plurality of groups of spectral coefficients;
decode from at least part of the encoded signal a mono synthetic audio signal; and
generate at least two channels of audio signals dependent on the mono synthetic audio signal, the received audio signal image gain signal, and the audio signal image position signal.

107. The apparatus as claimed in claim 106 wherein the at least one memory and the computer program code are further configured to, with the at least one processor, cause the apparatus at least to:
generate at least two channel gains dependent on the audio signal image position value and the at least one audio signal image gain level value, wherein at least one channel gain is associated with a first of the at least two channels of audio signals, and a further channel gain is associated with a second of the at least two channels of audio signals;
generate a first of the at least two channels of audio signals by multiplying the mono synthetic signal with the at least one channel gain associated with the first channel; and
generate a second of the at least two channels of audio signals by multiplying the mono synthetic signal with the further channel gain associated with the second channel.

108. The apparatus as claimed in claim 107, wherein the at least one memory and the computer program code are further configured to, with the at least one processor, cause the apparatus at least to:
further configured to transform the first and second of at least two channels of audio signals into the time domain by a frequency to time domain transformation.

109. The apparatus as claim 106, wherein the at least one memory and the computer program code are further configured to, with the at least one processor, cause the apparatus at least to:
read at least one audio signal image gain index from the gain level signal;
select one of at least two quantization functions by being configured to select the first quantization function if the at least one audio signal image gain index for a previous frame has a first pre determined index value; and
generate the at least one audio signal image gain value dependent on the at least one audio signal image gain index and the one of at least two quantization functions selected.

110. The apparatus as claimed in claim 109, wherein the at least one memory and the computer program code are further configured to, with the at least one processor, cause the apparatus at least to:
select a second of the at least two quantization functions if the at least one audio signal image gain index for a previous frame has a second predetermined index value.

111. The apparatus as claimed in claim 110, wherein the first predetermined index value is zero and the second predetermined index value is a non zero value.

112. The apparatus as claimed in claim 106 wherein the mono audio signal is a time domain signal, and wherein the at least one memory and the computer program code are further configured to, with the at least one processor, cause the apparatus at least to:
transform the time domain mono audio signal to a frequency domain mono audio signal.
